(19) United States
(12) Patent Application Publication
(10) Pub. No.: US 2017/0155899 A1
(43) Pub. Date: Jun. 1, 2017

(54) Image compression method and apparatus using matching

(71) Applicant: TONGJI UNIVERSITY, Shanghai (CN)

(72) Inventor: Tao Lin, Shanghai (CN)

(21) Appl. No.: 14/917,026

(22) PCT Filed: Sep. 5, 2014
(86) PCT No.: PCT/CN2014/086054

§ 371 Date: Sep. 7, 2016

(30) Foreign Application Priority Data
Sep. 7, 2013 (CN) 201310402757.9

(51) Int. Cl. H04N 19/105; H04N 19/139; H04N 19/176; H04N 19/182; H04N 19/174

(52) U.S. Cl. CPC H04N 19/105; H04N 19/182; H04N 19/174; H04N 19/176; H04N 19/139

(57) ABSTRACT

The present invention is to code a current pattern using a reference pattern that has different shape and/or size from the current pattern being coded. A portion or entire of the reference pattern provides reference pixels for one part of the current pattern. A portion or entire of the reference pattern also provides or repeatedly reference pixels for the other part of the current pattern.

### TECHNICAL FIELD

The invention relates generally to the field of digital picture and video compression, and more particularly, to picture and video compression using pattern matching.

### BACKGROUND OF THE INVENTION

With the development and popularization of a new generation of cloud computing and information processing model and platform which use remote desktop as a paradigm, interconnection has become a reality and increasingly become a mainstream trend among multiple computers, between the host computer and other digital devices including the smart TV, smart phones, tablet PCs, etc and among all kinds of digital devices. Thus, efficient real-time screen transfer from the server (cloud) to client currently becomes urgent needs. Since the amount of screen video data to be transmitted is large, taking 2048×1536 pixel resolution, 60 frames per second refresh rate, 24-bit true color tablet screen content for example, the data to be transmitted are 2048×1536×60×24=4320 megabits data per second. It is impossible to achieve real-time transmission for so many data in real network conditions. Hence, for computer screen content, effective data compression is essential.

To make full use of the characteristics of the computer screen content for ultra-efficient compression is a major goal of several international standards, national standards, and industry standards, such as HEVC (High Efficiency Video Coding), AVS (Audio Video Coding Standard), and IEEE (Institute of Electrical and Electronics Engineers) 1857 standard.

A distinguishing feature of computer screen content is that the same picture usually contains a lot of similar or even identical pixel patterns. For example, computer screen content often has Chinese or English texts that are composed of a few basic strokes and we can find a lot of similar or identical strokes in the same picture. Common menus, icons, etc. in computer screen content also have many same or similar patterns. In the prior art of picture and video compression, intra prediction mode only references adjacent pixel samples and can not use similarity or identity in a picture to improve compression efficiency. In prior art, intra motion compensation mode uses several fixed size (e.g. 4×4, 8×8, 16×16, 32×32, 64×64 pixel) blocks for block matching coding, but the fixed size reference matching block must be completely inside a reconstructed reference pixel sample set, thus cannot overlap the non-reconstructed current matched block being coded. Especially, when a matching block is large, the distance between the corresponding pixel samples of the matching block and the matched block is also too large to do short distance matching, thus the efficiency of matching coding is greatly reduced. Therefore, we must go beyond the prior art, and in particular, solve the problem of no overlapping between the matching block and matched block in the prior art of matching coding to significantly improve compression efficiency.

The natural format of a digital video signal of screen content is a sequence of picture. A picture is generally a rectangular area consisting of several pixels. If a digital video signal has 50 frames per second, a 30-minute digital video signal is a sequence consisting of 30×60×50=90000 pictures. A sequence of picture is sometimes called a video sequence or a sequence. When the digital video signal is coded, it is coded a picture by a picture. At any one time, the picture being coded is called the current encoded picture or the current encoded frame. Similarly, when the compressed stream (stream is also called bitstream) of digital video signal is decoded, it is decoded a picture stream by a picture stream. At any one time, the picture being decoded is called the current decoded picture or the current decoded frame. The current encoded picture (frame) and the current decoded picture are collectively referred to as the current picture (frame).

In common practice, when a picture is coded, the picture is divided into several MxIVI pixel sub-pictures called “coding unit (CU)”, sub-pictures are coded piece by piece based on CU. The size of common M is 4, 8, 16, 32, or 64. Thus, when a video picture sequence is coded, each coding unit (CU) of each frame of the picture sequence is coded. At any one time, CU being coded is called the current coded CU. Similarly, when decoding, each coding unit of each picture, i.e. CU, is decoded in turn, and finally the entire video picture sequence is reconstructed. At any one time, CU being decoded is called the current decoded CU. The current encoded CU and the current decoded CU are collectively referred to as the current CU.

To adapt to the different content and feature of each part within a picture and in particular to carry out the most efficient coding, the size of CUs within a picture can be different, some 8×8, some 64×64, and so on. In order to make CUs with different sizes seamlessly stitch together, a picture will always be divided into N×N pixel “Largest coding unit (LCU)” with the same size, also known as CU with depth of 0. Then, a CU with depth of 0 can be divided into four

$$\frac{N}{2} \times \frac{N}{2}$$

pixel CU with depth of 1 with the same size. A CU with depth of 1 can also be further divided into four

$$\frac{N}{4} \times \frac{N}{4}$$

pixel CU with depth of 2 with the same size. So on, to continue to divide, eventually a predetermined maximum depth D can be reached, that is, the size of the corresponding CU can be down to the minimum value

$$\frac{N}{{2}^{D}} \times \frac{N}{{2}^{D}} .$$

CU with the largest depth D is called the “smallest coding unit (SCU).” In the case of the most commonly used N=64 and D=3, a picture is divided into 64×64 pixel LCU, i.e. CU with depth of 0. A LCU can be divided into four 32×32 pixel CUs with depth of 1. A CU with depth of 1 can be divided into four 16×16 pixel CUs with depth of 2. A CU with depth of 2 can be divided into four 8×8 pixel CUs with depth of 3, i.e. the deepest SCU. When a CU is coded and decoded, the CU can also be split into two or four sub-blocks which are predictively coded and decoded separately. For orderly predictive encoding and decoding, all smallest sub-blocks of a LCU must have a predetermined order. In the case of the 64×64 pixel LCU and the 4×4 pixel smallest sub-block, a LCU has 256 smallest sub-blocks, encoding and decoding and corresponding reconstructed order are shown in FIG. 1. The basic rule of the order shown in FIG. 1 is described below.
1) The first (highest) level numbering: a 64×64 pixel block (LCU) is divided into four 32×32 pixel blocks, the numbering order of four blocks is the top-left, top-right, bottom-left, bottom-right. That is, firstly all smallest sub-blocks are numbered (numbers from 0 to 63) in the top-left block, and then all smallest sub-blocks are numbered (numbers from 64 to 127) in the top-right block, then all smallest sub-blocks are numbered (numbers from 128 to 191) in the bottom-left block, finally all the smallest sub-blocks are numbered (numbers from 192 to 255) in the bottom-right block.
2) The second level numbering: a 32×32 pixel block is dividing into four 16×16 pixel blocks, the numbering order of four blocks is also the top-left, top-right, bottom-left, bottom-right. That is, firstly all smallest sub-blocks are numbered (numbers from 0 to 15 or 64 to 79 or 128 to 143 or 192 to 207) in the top-left block, and then all smallest sub-blocks are numbered (No. 16 to 31 or 80 to 95 or 144 to 159 or 208 to 223) in the top-right block, then all smallest sub-blocks are numbered (No. 32 to 47 or 96 to 111 or 160 to 175 or 224 to 239) in the bottom-left block, finally all smallest sub-blocks are numbered (No. 48 to 63 or 112 to 127 or 176 to 191 or 240 to 255) in the bottom-right block.
3) The third level numbering: a 16×16 pixel block is dividing into four 8×8 pixel blocks, the numbering order of four blocks is likewise the top-left, top-right, bottom-left, and bottom-right.
4) The fourth (lowest) level numbering: a 8×8 pixel block is dividing into four 4×4 pixel blocks (the smallest sub-blocks), the numbering order of four blocks is likewise the top-left, top-right, bottom-left, and bottom-right.

### Therefore,

The top-left corner 8×8 pixel block of the top-left corner 16×16 pixel block of the top-left corner 32×32 pixel block of a 64×64 pixel block is divided into 4=2×2 4×4 pixel smallest sub-blocks which have numbers of 0, 1, 2, 3, respectively, as shown in FIG. 1.
The top-right corner 8×8 pixel block of the top-left corner 16×16 pixel block of the top-left corner 32×32 pixel block of a 64×64 pixel block is divided into 4=2×2 4×4 pixel smallest sub-blocks which have number of 4, 5, 6, 7, respectively, as shown in FIG. 1.
The bottom-left corner 8×8 pixel block of the top-left corner 16×16 pixel block of the top-left corner 32×32 pixel block of a 64×64 pixel block is divided into 4=2×2 4×4 pixel smallest sub-blocks which have number of 8, 9, 10, 11, respectively, as shown in FIG. 1.
The bottom-right corner 8×8 pixel block of the top-left corner 16×16 pixel block of the top-left corner 32×32 pixel block of a 64×64 pixel block is divided into 4=2×2 4×4 pixel smallest sub-blocks which have number of 12, 13, 14, 15, respectively, as shown in FIG. 1.
According to the above rule, we can number the smallest sub-blocks of the top-left, top-right, bottom-left, bottom-right blocks on all levels, and finally obtain the numbers of all 256 smallest sub-blocks, as shown in FIG. 1.

From the above rule, 2×2=4 vertically and horizontally adjacent smallest sub-blocks compose a 8×8 pixel block. 2×2=4 vertically and horizontally adjacent 8×8 pixel blocks compose a 16×16 pixel block. 2×2=4 vertically and horizontally adjacent 16×16 pixel blocks compose a 32×32 pixel block. 2×2=4 vertically and horizontally adjacent 32×32 pixel blocks compose a 64×64 pixel block (LCU).

As a result, in picture and video compression, a picture is divided into coding unit (CU) of predetermined sizes such as 4×4 or 8×8 or 16×16 or 32×32 or 64×64. Error! Reference source not found. shows a portion of a picture divided into CUs, where the size of the largest CU (LCU) is 64×64 pixels, while the size of the smallest CU (SCU) is 4×4 pixels. In Error! Reference source not found., an LCU is further divided into 256 SCUs numbered from 0 to 255, which indicate the order of coding in unit of SCU.

A color pixel typically has three components. The two most common pixel color formats are GBR color format consisting of green component, blue component and red component and YUV color format consisting of a luma component and two chroma components. The color format known as YUV actually includes a variety of color formats, such as YCbCr color format. Thus, when a CU is coded, a CU is divided into three component planes (G plane, B plane, R plane or Y plane, U plane, V plane), and three component planes are coded, respectively. Three components of a pixel can also be packed together to combine into a 3-tuple, and the whole CU consisting of these 3-tuples are coded. The former pixel and arrangement mode of its components is called picture (and its CU) planar format, and then the latter pixel and arrangement mode of its components is called picture (and its CU) packet format. GBR color format and YUV color format of pixel are 3-component representation format of pixel.

In addition to three-component representation format of pixel, another common pixel representation format of the prior art is palette index representation format. In the palette index representation format, a pixel value can also be represented with the palette index. Palette space stores three component values or approximate values of pixel which need to be represented. The palette address is called index of the pixel color value stored in the address. An index can show a component of pixel, and can also show three components of pixel. Palette can be one, and can also be more. In the case of a plurality of palettes, a complete index is actually composed of a palette number and an index of the palette with the palette number. Index representation format of pixels refers to using an index to represent the pixels. Index representation format of pixels is also known as indexed color or pseudo color representation format of pixels in the prior art, or often called indexed pixel or pseudo pixel or pixel index or index directly. The process of representing the pixel using its index representation format is also called indexing or indexation.

Other common representation formats of pixel include CMYK representation format and gray-scale representation format.

According to whether downsampling is performed for chroma component or not, YUV color format is divided into a number of sub-formats: in YUV4:4:4 color format, a pixel consists of a Y component, a U component, a V component; in YUV4:2:2 color format, two horizontally adjacent pixels consist of 2 Y components, a U component, a V component; in YUV4:2:0 color format, four vertically and horizontally adjacent 2×2 spatial position arranged pixels consist of four Y components, a U component, a V component. A component is generally represented as an 8 to 16-bit number. YUV4:2:2 pixel color format and YUV4:2:0 pixel color format are both obtained by applying chroma component downsampling to YUV4:4:4 pixel color format. A component is also known as a pixel sample or simply as a sample.

The most basic element of encoding or decoding can be a pixel, or a pixel component, or a pixel index (i.e. indexed pixel). In encoding or decoding, a pixel or a pixel component or an indexed pixel are collectively referred to as a pixel sample, and also sometimes known as a pixel value or simply as a sample.

In the present invention and the patent application of the present invention, the term “pixel sample”, “pixel value”, “sample”, “indexed pixel” and “pixel index” are synonymous. According the context, one can tell clearly that these terms represent “pixel” or “a pixel component” or “pixel index” or represent any one of the three simultaneously. If the context is not clear, they represent any one of the three simultaneously.

In compressing computer screen content and video data, intra block matching (also known as intra motion compensation or intra block copying) and dividing block (e.g. 8×8 pixel samples) into finer mini-blocks (e.g. 4×2 pixel sample or 8×2 pixel sample or 2×4 pixel sample or 2×8 pixel sample) or lines (i.e. mini-block with height of one or width of one, e.g. 4×1 pixel sample or 8×1 pixel sample or 1×4 pixel sample or 1×8 pixel sample) or arranging the pixel sample within a block into a string (such as string with width of one pixel sample and length of 64 pixel samples or string with width of two pixel samples and length of 32 pixel samples) that string length is much greater than the width to do mini-block matching (also called intra mini-block copying) or line matching (also known as strip matching or intra line copying or intra strip copying) or string matching (also known as string copying or intra string copying) using mini-block or line or variable length sub-string of intra string as the smallest matching unit are all effective technologies.

In the present invention and patent application of the present invention, an encoding block or a decoding block refers to a encoding or decoding region in a picture. An enoding block and a decoding block are collectively referred to as a block.

Therefore, in the present invention and patent application of the present invention:

Block includes but is not limited to commonly said block, mini-block, line (strip) and string.

Block matching includes but is not limited to commonly said block matching, block copying, mini-block matching, mini-block copying, line matching, strip matching, line copying, strip copying, string matching, string copying.

Matching block includes but is not limited to commonly referred matching block, matching mini-block, matching line, matching strip, matching string.

Matched block includes but is not limited to commonly referred matched block, matched mini-block, matched line, matched strip, matched string.

Block is a region composed of a plurality of pixel values. A block can be composed of “pixel” or “pixel component” or “indexed pixel” or these three mixed composition or mixture of any two of these three.

Block matching coding is that when a coding block is coded, in a predetermined search range of the reconstructed reference pixel sample set, a matching block (known as the best-matching block) having a small matching error with the coded block (i.e. matched block) is found, then the relative position between the matched block and the best-matching block (called motion vector that is simply referred to as MV) is written into the compressed video bitstream.

Block matching decoding refers to be that when a compressed video bitstream segment of a decoding block is decoded, according to the parsed MV from the compressed video bitstream, the position of the matching block is determined in the reconstructed reference pixel sample set, and then the said matching block is copied and pasted into the said decoding block (i.e. matched block) position, that is, the value of the decoding block is directly or indirectly set to a value equal to the matching block.

In the existing block matching technique, to completely calculate matching error and to copy and past the whole matching block into the position of matched block in the process of encoding, decoding and reconstructing, the matching block must completely exist in the reconstructed reference pixel sample set, that is, the matching block is an original completely reconstructed matching block. In particular, there should be no overlapping part between the matching block and the matched block, that is, a block cannot partially match itself (referred to as partially self-matching or partial self-matching).

Taking the case of the previously said 64×64 pixel LCU and 4×4 pixel smallest sub-block for example, when any CU is encoded or decoded (the CU is called the current CU wherein the LUC is called the current LCU), according to the preceding said numbering rule of 256 smallest sub-blocks, we can determine the reconstructed reference pixel sample sets as follows:
1) In the current LCU, all smallest sub-blocks satisfying the following condition: their number is less than the smallest sub-block number of the current CU;
2) According to a predetermined encoding or decoding order, all LCUs completed encoding or decoding and reconstructing usually at least include the left LCU of the current LCU (the left LCU), the top LCU of the current LCU (the top LCU) and the top-left LCU of the current LCU (the top-left LCU).

FIG. 2 is a case of the current CU and its reconstructed reference pixel sample set. The current CU is a 16×16 pixel CU consisting of 16 smallest sub-blocks whose numbers are from 192 to 207. For this current CU, its reconstructed reference pixel sample set (shaded area in FIG. 2) includes all smallest sub-blocks whose numbers are less than 192. FIG. 2 also illustrates the position of matched block, i.e. the current CU and matching block. The entire matching block locates in the reconstructed reference pixel sample set. The matched block and the matching block will not intersect, that is, there will be no overlapping part.

FIG. 3 is the second example of the current CU and its reconstructed reference pixel sample set. The current CU is an 8×8 pixel CU consisting of 4 smallest sub-blocks whose numbers are from 244 to 247. For this current CU, its reconstructed reference pixel sample set (shaded area in FIG. 3) includes all smallest sub-blocks whose numbers are less than 244. FIG. 3 also illustrates the position of matched block, i.e. the current CU and matching block. The entire matching block locates in the reconstructed reference pixel sample set. The matched block and the matching block will not intersect, that is, there will be no overlapping part.

FIG. 4 is the third example of the current CU and its reconstructed reference pixel sample set. The current CU is a 16×16 pixel CU consisting of 16 smallest sub-blocks whose numbers are from 80 to 95. For this current CU, its reconstructed reference pixel sample set (shaded area in FIG. 4) includes all smallest sub-blocks whose numbers are less than 80. FIG. 4 also illustrates the position of matched block, i.e. the current CU and matching block. The entire matching block locates in the reconstructed reference pixel sample set. The matched block and the matching block will not intersect, that is, there will be no overlapping part.

FIG. 5 is the fourth example of the current CU and its reconstructed reference pixel sample set. The current CU is a 8×8 pixel CU consisting of 4 smallest sub-blocks whose numbers are from 36 to 39. For this current CU, its reconstructed reference pixel sample set (shaded area in FIG. 5) includes all smallest sub-blocks whose numbers are less than 36. FIG. 5 also illustrates the position of matched block, i.e. the current CU and matching block. The entire matching block locates in the reconstructed reference pixel sample set. The matched block and the matching block will not intersect, that is, there will be no overlapping part.

FIG. 6 is the fifth example of the current CU and its reconstructed reference pixel sample set. The current CU is a 8×8 pixel CU consisting of 4 smallest sub-blocks whose numbers are from 168 to 171. For this current CU, its reconstructed reference pixel sample set (shaded area in FIG. 6) includes all smallest sub-blocks whose numbers are less than 168. FIG. 6 also illustrates the position of matched block, i.e. the current CU and matching block. The entire matching block locates in the reconstructed reference pixel sample set. The matched block and the matching block will not intersect, that is, there will be no overlapping part.

An arbitrary pixel sample of a picture is usually (but not limited to) represented by a coordinates (X, Y) relative to a predetermined reference point (i.e. origin, usually, but not limited to the picture point of the top-left pixel sample) in the picture, while the value of the pixel sample P at the coordinates (X, Y) is represented by P (X, Y). The X increases usually (but not limited to) on the right direction, and the Y increases usually (but not limited to) on the downward direction. Let (Xc, Yc) be the coordinates of the top-left pixel sample of a matched block with width of Nx and height of Ny, and (Xr, Yr) are the coordinates of the top-left pixel sample of a matching block (it must have the same width and height with the matched block). According to the plane analytic geometry knowledge, that the entire matching block is within the reconstructed reference pixel sample set, i.e. a necessary condition that all pixel samples of matching block are reconstructed pixel samples, is that the matching block can't have any intersection (i.e., overlapping) part. The necessary condition is represented by the relationship of the coordinates, width and height as follows:

|Xr−Xe|≧Nx or |Yr−Yc|≧Ny.

In the case that all pixel samples of a matching block are reconstructed pixel samples, the operation that the matching block is copied and pasted into the position of matched block, that is, the values of all pixel samples of the matching block are directly or indirectly assigned to the matched block, can be completed using (but not limited to) any one of the following assignment statements or their combination:

Assignment statement 1 of the original completely reconstructed matching block

for (y=0; y<Ny; ++y)

for (x=0; x<Nx; ++x)

P(Xc+x,Yc+y)=P(Xr+x,Yr+y)

Assignment statement 2 of the original completely reconstructed matching block

for (y=0; y<Ny; ++y)

for (x=0; x<Nx; ++x)

P(Xc+Nx−1−x,Yc+y)=P(Xr+Nx−1−x,Yr+y)

Assignment statement 3 of the original completely reconstructed matching block

for (y=0; y<Ny; ++y)

for (x=0; x<Nx; ++x)

P(Xc+x,Yc+Ny−1−y)=P(Xr+x, Yr+Ny−1−y)

Assignment statement 4 of the original completely reconstructed matching block

for (y=0; y<Ny; ++y)

for (x=0; x<Nx; ++x)

P(Xc+Nx−1−x,Yc+Ny−1−y)=P(Xr+Nx−1−x,Yr+Ny−1−y)

Assignment statement 5 of the original completely reconstructed matching block

for (x=0; x<Nx; ++x)

for (y=0; y<Ny; ++y)

P(Xc+x,Yc+y)=P(Xr+x,Yr+y)

Assignment statement 6 of the original completely reconstructed matching block

for (x=0; x<Nx; ++x)

for (y=0; y<Ny; ++y)

P(Xc+Nx−1−x,Yc+y)=P(Xr+Nx−1−x,Yr+y)

Assignment statement 7 of the original completely reconstructed matching block

for (x=0; x<Nx; ++x)

for (y=0; y<Ny; ++y)

P(Xc+x,Yc+Ny−1−y)=P(Xr+x,Yr+Ny−1−y)

Assignment statement 8 of the original completely reconstructed matching block

for (x=0; x<Nx; ++x)

for (y=0; y<Ny; ++y)

P(Xc+Nx−1−x,Yc+Ny−1−y)=P(Xr+Nx−1−x,Yr+Ny−1−y)

Since the entire matching block is within the reconstructed reference pixel sample set samples, the matching block and the matched block will not intersect, and the above eight assignment statements are completely equivalent.

When matching block is a vertical matching strip (i.e. matching block with width of Nx=1), the assignment statement of the original completely reconstructed matching strip is (but not limited to) any one of the following assignment statements or their combination:

Assignment statement 1 of the vertical original completely reconstructed matching strip

for (y=0; y<Ny; ++y)

P(Xc, Yc+y)=P(Xr, Yr+y)

Assignment statement 2 of the vertical original completely reconstructed matching strip

for (y=0; y<Ny; ++y)

P(Xc,Yc+Ny−1−y)=P(Xr,Yr+Ny−1−y)

The above two assignment statements are completely equivalent.

When matching block is a horizontal matching strip (i.e. matching block with height of Ny=1), the assignment statement of the original completely reconstructed matching strip is (but not limited to) any one of the following assignment statements or their combination:

Assignment statement 1 of the horizontal original completely reconstructed matching strip

for (x=0; x<Nx; ++x)

P(Xc+x,Yc)=P(Xr+x,Yr)

Assignment statement 2 of the horizontal original completely reconstructed matching strip

for (x=0; x<Nx; ++x)

P(Xc+Nx−1−x,Yc)=P(Xr+Nx−1−x,Yr)

The above two assignment statements are completely equivalent.

When matching block is matching string (i.e., matching block with width of a smaller non-independent parameter W and length of an independent variable parameter L), the coordinates (X, Y) of the pixel sample become a one-dimensional address K, and the value of the pixel sample P of the address K is represented as P(K). Let Kc be the address of the first pixel sample of a matched string with length of L, and Kr is the address of the first pixel sample of a matching string (must have the same length with the matched string). The assignment statement of the original completely reconstructed matching string is (but not limited to) any one of the following assignment statements or their combination:

Assignment statement 1 of the original completely reconstructed matching string

for (k=0; k<L; ++k)

P(Kc+k)=P(Kr+k)

Assignment statement 2 of the original completely reconstructed matching string

for (k=0; k<L; ++k)

P(Kc+L−1−k)=P(Kr+L−1−k)

The above two assignment statements are completely equivalent.

Synonyms of matching block include but are not limited to reference block, prediction block. In the process of encoding, synonyms of matched block include but are not limited to original block, current block, current encoding block. In the process of decoding and reconstructing, synonyms of matched block include but are not limited to constructed block, reconstructed block, current block, current decoding block.

Synonyms of matching strip include but are not limited to reference strip, prediction strip. In the process of encoding, synonyms of matched strip include but are not limited to original strip, current strip, current coding strip. In the process of decoding and reconstructing, synonyms of matched strip include but are not limited to constructed strip, reconstructed strip, current strip, current decoding strip.

Synonyms of matching string include but are not limited to reference string, prediction string. In the process of encoding, synonyms of matched string include but are not limited to original string, current string, current encoding string. In the process of decoding and reconstructing, synonyms of matched string include but are not limited to constructed string, reconstructed string, current string, current decoding string.

In the present invention and patent application of the present invention, synonyms of matching coding include but are not limited to copying coding and generalized predictive coding, and synonyms of matching decoding include but are not limited to copying decoding and generalized predictive decoding. In the present invention and patent application of the present invention, the generalized predictive coding is called predictive coding for short, generalized predictive decoding is called predictive decoding for short. Thus, synonyms of block matching coding, mini-block matching coding, line matching coding, strip matching coding, string matching coding, arbitrary shape matching coding respectively include but are not limited to block copying coding and block predictive coding, mini-block copying coding and mini-block predictive coding, line copying coding and line predictive coding, stripe copying coding and strip predictive coding, string copying coding and string predictive coding, arbitrary shape copying coding and arbitrary shape predictive coding. Similarly, synonyms of block matching decoding, mini-block matching decoding, line matching decoding, strip matching decoding, string matching decoding, arbitrary shape matching decoding respectively include but are not limited to block copying decoding and block predictive decoding, mini-block copying decoding and mini-block predictive decoding, line copying decoding and line predictive decoding, stripe copying decoding and strip predictive decoding, string copying decoding and string predictive decoding, arbitrary shape copying decoding and arbitrary shape predictive decoding.

In the present invention and patent application of the present invention, copying coding includes but is not limited to block copying coding, intra block copying coding, mini-block copying coding, intra mini-block copying coding, line copying coding, intra line copying coding, strip copying coding, intra strip copying coding, string copying coding, intra string copying coding, arbitrary shape copying coding, intra arbitrary shape copying coding. Copying decoding includes but is not limited to block copying decoding, intra block copying decoding, mini-block copying decoding, intra mini-block copying decoding, line copying decoding, intra line copying decoding, strip copying decoding, intra strip copying decoding, string copying decoding, intra string copying decoding, arbitrary shape copying decoding, intra arbitrary shape copying decoding.

In the present invention and patent application of the present invention, predictive coding includes but is not limited to block predictive coding, intra block predictive coding, mini-block predictive coding, intra mini-block predictive coding, line predictive coding, intra line predictive coding, strip predictive coding, intra strip predictive coding, string predictive coding, intra string predictive coding, arbitrary shape predictive coding, intra arbitrary shape predictive coding. Predictive decoding includes but is not limited to block predictive decoding, intra block predictive decoding, mini-block predictive decoding, intra mini-block predictive decoding, line predictive decoding, intra line predictive decoding, strip predictive decoding, intra strip predictive decoding, string predictive decoding, intra string predictive decoding, arbitrary shape predictive decoding, intra arbitrary shape predictive decoding.

Since the entire matching block is limited to the reconstructed reference pixel sample set in the prior art of block matching, matched block and matching block can not overlap, so that many possible short-distance matching block in a picture cannot be effectively used, resulting in very low coding efficiency for such pictures and patterns.

### SUMMARY OF THE INVENTION

One aspect of the present invention is to code a current pattern using a reference pattern that has different shape and/or size from the current pattern being coded. A portion or entire of the reference pattern provides reference pixels for one part (i.e. first part) of the current pattern. A portion or entire of the reference pattern also provides reference pixels for the other part (i.e. rest part) of the current pattern.

In another aspect of the present invention, a portion or entire of one part (i.e. first part) of the current pattern provides reference pixels for the other part (i.e. rest part) of the current pattern.

### DESCRIPTION OF SOME SPECIFIC EMBODIMENTS

The present invention recognizes that the conventional method and apparatus of pattern matching, especially, intra-picture pattern matching, for example, intra block copy in the prior arts such as HEVC screen content coding extension, are not efficient. This is due to that the conventional pattern matching requires and restricts that a reference pattern that matches a current pattern being coded must be completely inside a predetermined region, i.e. a referenceable region (also called a reference region or a reference range) and the reference pattern must have exactly the same shape and size (number of pixels or pixel samples) as the current pattern being coded. FIG. 2 to FIG. 6 show a few examples of reference patterns that have exactly the same shape and size as the corresponding current patterns and completely locate inside the referenceable region shown in shaded area. Note that the shaded area in the current LCU is the squares marked by numbers smaller than the numbers in the current CU. Therefore, the shaded area (the referenceable region) increases when the current CU changes, i.e. when the number of coded CUs increases.

The present invention improves coding efficiency in pattern matching by removing the restriction. This is accomplished by allowing that
1) A reference pattern may have different shape and size from a corresponding current pattern being coded (matched) in a suitable way. For example, the reference pattern matches a part of the current pattern and actually locates at the boundary of the reference region as shown in FIG. 7 and FIG. 8.
2) A reference pattern can repeatedly provide reference pixels for different parts of a current pattern being coded. That is, a reference pattern can provide the same reference pixels for multiple parts of a current pattern being coded. For example, the entire of a reference pattern matches (provides reference pixels for) a first part of a current pattern and a portion of the same reference pattern also provides (or repeatedly provides) reference pixels for the rest part of the current pattern.

FIG. 9 shows the following four embodiments of the present invention:
1) The first part of a current pattern with rectangular shape is the top part of the current pattern. A portion of the first part (i.e. top part) provides reference pixels for the rest part (i.e. bottom part) of the same current pattern. The first part is larger than the rest part, thus only a small portion of the first part is used to provide reference pixels for the rest part
2) The first part of a current pattern with rectangular shape is the top part of the current pattern. A portion of the first part (i.e. top part) provides reference pixels for the rest part (i.e. bottom part) of the same current pattern. The first part is smaller than the rest part, thus a portion or entire of the first part is used to repeatedly provide reference pixels for the rest part. For example, firstly, entire of the first part is used to provide reference pixels for the top portion of rest part; secondly, a portion of the first part is used again to provide reference pixels for the bottom portion of rest part.
3) The first part of a current pattern with rectangular shape is the left part of the current pattern. A portion of the first part (i.e. left part) provides reference pixels for the rest part (i.e. right part) of the same current pattern. The first part is larger than the rest part, thus only a small portion of the first part is used to provide reference pixels for the rest part
4) The first part of a current pattern with rectangular shape is the top part of the current pattern. A portion of the first part (i.e. left part) provides reference pixels for the rest part (i.e. right part) of the same current pattern. The first part is smaller than the rest part, thus a portion or entire of the first part is used to repeatedly provide reference pixels for the rest part. For example, firstly, a portion of the first part is used to provide reference pixels for the left portion of rest part; secondly, entire of the first part is used again to provide reference pixels for the right portion of rest part.

FIG. 10 shows the following five more embodiments of the present invention:
5) The first part of a current pattern with rectangular shape is the top-left part of the current pattern. The first part provides reference pixels for the rest part in 2 steps. In step 1, a portion or entire of the first part provides reference pixels for the bottom-left portion of the rest part of the same current pattern. Then, in step 2, a portion or entire of the left portion (i.e. the first part plus the bottom-left portion of the rest part) provides (or repeatedly provides) reference pixels for the right portion of the rest part of the same current pattern.
6) The first part of a current pattern with rectangular shape is the top-left part of the current pattern. The first part provides reference pixels for the rest part in 2 steps. In step 1, a portion or entire of the first part provides reference pixels for the top-right portion of the rest part of the same current pattern. Then, in step 2, a portion or entire of the top portion (i.e. the first part plus the top-right portion of the rest part) provides (or repeatedly provides) reference pixels for the bottom portion of the rest part of the same current pattern.
7) The first part of a current pattern with rectangular shape is a Γ-shape part of the current pattern. A Γ-shape portion or entire of the first part provides (or repeatedly provides) reference pixels for the rest part of the same current pattern.
8) The Γ-shape portion in the previous embodiment degenerates into a left rectangle to provide (or repeatedly provide) reference pixels for the rest part of the same current pattern.
9) The Γ-shape portion in the previous embodiment degenerates into a top rectangle to provide (or repeatedly provide) reference pixels for the rest part of the same current pattern.

FIG. 15 shows the following six more embodiments of the present invention wherein besides providing reference pixels for the first part of a current pattern being coded, a portion or entire of a reference pattern also provides (or repeatedly provides) reference pixels for the rest part of the same current pattern being coded:
10) A reference pattern consists of two rectangles: rectangle #1 and rectangle #2. A portion of rectangle #1 plus entire of rectangle #2 provides reference pixels for the first part of a current pattern being coded. Furthermore, a portion or entire of rectangle #1 provides (or repeatedly provides) reference pixels for the rest part of the same current pattern.
11) A reference pattern consists of two rectangles: rectangle #1 and rectangle #2. A portion of rectangle #2 plus entire of rectangle #1 provides reference pixels for the first part of a current pattern being coded. Furthermore, a portion or entire of rectangle #2 provides (or repeatedly provides) reference pixels for the rest part of the same current pattern.
12) A reference pattern consists of two rectangles: rectangle #1 and rectangle #2. Entire of rectangle #2 provides reference pixels for the first part of a current pattern being coded. Furthermore, a portion or entire of rectangle #1 provides (or repeatedly provides) reference pixels for the rest part of the same current pattern.
13) A reference pattern consists of one rectangle: rectangle #2. A portion of rectangle #2 provides reference pixels for the first part of a current pattern being coded. Furthermore, a portion or entire of rectangle #2 provides (or repeatedly provides) reference pixels for the rest part of the same current pattern.
14) A reference pattern consists of one rectangle: rectangle #1. A portion of rectangle #1 provides reference pixels for the first part of a current pattern being coded. Furthermore, a portion or entire of rectangle #1 provides (or repeatedly provides) reference pixels for the rest part of the same current pattern.
15) A reference pattern consists of two rectangles: rectangle #1 and rectangle #2. Entire of rectangle #1 provides reference pixels for the first part of a current pattern being coded. Furthermore, a portion or entire of rectangle #2 provides (or repeatedly provides) reference pixels for the rest part of the same current pattern.

FIG. 16 shows the following three more embodiments of the present invention wherein besides providing reference pixels for the first part of a current pattern being coded, a portion or entire of a reference pattern also provides (or repeatedly provides) reference pixels for the rest part of the same current pattern being coded:
16) A reference pattern of 5 pixels provides reference pixels for the 5-pixel first part of an 8-pixel current pattern being coded. Furthermore, a 3-pixel portion of the reference pattern provides reference pixels for the 3-pixel rest part of the same 8-pixel current pattern.
17) A reference pattern of 3 pixels provides reference pixels for the 3-pixel first part of an 8-pixel current pattern being coded. Furthermore, entire of the reference pattern also provides reference pixels for a 3-pixel portion of the 5-pixel rest part and a 2-pixel portion of the reference pattern further provides reference pixels for a 2-pixel portion of the 3-pixel rest part, of the same 8-pixel current pattern.
18) A reference pattern of 1 pixel provides reference pixels for the 1-pixel first part of an 8-pixel current pattern being coded. Furthermore, entire of the reference pattern repeatedly provides (i.e. repeats 7 times to provide) reference pixels for the 7-pixel rest part of the same 8-pixel current pattern.

In the present invention, a current pattern can be a macroblock or a block or a miniblock or a strip or a line or a coding unit or a largest coding unit or a smallest coding unit or a prediction unit.

### DETAILED DESCRIPTION OF THE INVENTION

In order to solve the problem in the prior art of picture and video coding and decoding, the present invention provides a picture encoding and decoding method or apparatus that allow matching block partially within the reconstructed reference pixel sample set, especially, allow intersection (i.e., having overlapping part, also known as partially self-matching or partial self-matching) between matched block and matching block. The matching block in which only one part rather than a complete block is within the reconstructed reference pixel sample set is called partially reconstructed matching block. On the other hand, the matching block being completely within the reconstructed reference pixel sample set is called the original completely reconstructed matching block.

The main technical features of the present invention are shown in FIG. 7 and FIG. 8. The corresponding matching block of the current block (matched block) is not necessarily located completely in the reconstructed reference pixel sample set, as long as there is at least one pixel sample being located in the reconstructed reference sample set, thus the present invention allows the matched block and the matching block to have the overlapping part. FIG. 7 illustrates two 16×16 pixel CUs (matched blocks) and three 8×8 pixel CUs (matched blocks). FIG. 8 illustrates two 16×16 pixel CUs (matched blocks) and five 8×8 pixel CU (matched blocks). Their corresponding matching blocks are all partially reconstructed matching blocks, that is, only a fraction (shaded area in figure) is in the reconstructed reference pixel sample set. The part in the reconstructed reference pixel sample set of a matching block is called for short the reconstructed part of the matching block, while the rest is called for short the non-reconstructed part of the matching block. It can be seen from the figure (can also be rigorously proven) that the reconstructed part (shaded area in figure) of a partially reconstructed matching block has four cases:
1) The reconstructed part of a partially reconstructed matching block is the top part of the matching block.
2) The reconstructed part of a partially reconstructed matching block is the left part of the matching block.
3) The reconstructed part of a partially reconstructed matching block is the top-left part of the matching block.

4) The reconstructed part of a partially reconstructed matching block is the part removing the bottom-right part of the matching block, that is, the non-reconstructed part is the bottom-right part. In this case, the reconstructed part is Γ-shape consisting of two horizontal rectangles called left rectangle and right rectangle, respectively.

When block is line (i.e. block with height or width of 1 sample), the above four cases become two cases, i.e. case 1) and case 2), while case 3) and 4) can not exist.

When block is string (i.e. the pixel sample within block are arranged into a string for which the length is much greater than the width), the above four cases become one case, i.e. the reconstructed part of a partially reconstructed matching block is the front part of the matching block.

Matching blocks and matched blocks shown in FIG. 7 and FIG. 8 can be represented by the packed format matching blocks and matched blocks, and can also be the matching block and matched block of a component (sample) using planar format. Thus the method and apparatus of the present invention can be applied to the encoding, decoding and reconstructing for packed format pixels of LCU and CU, and can also be applied to the encoding, decoding and reconstructing for planar format pixels of LCU and CU.

In encoding method and apparatus of the present invention, the basic distinctive technical feature is that in best-matching block searching of block matching coding for the current coding block, the candidate matching blocks used as reference (i.e. all possible best-matching blocks located within a predetermined search range) are not necessarily located in the reconstructed reference pixel sample set completely, that is, can contain non-reconstructed part. For the matching block containing the non-reconstructed part, when the matching error between the candidate reference matching block and the matched block currently being coded is calculated, firstly the non-reconstructed part of the said matching block must be filled by using some pixel samples inside or near the reconstructed part of the said matching block or by using other pixel samples obtained by a predetermined way, and then the matching error can be calculated. Equivalently, these two operations of said filling the non-reconstructed part and calculating matching error can also be combined into a single step to complete, that is, the pixel samples to be used for filling the non-reconstructed part are directly used for calculating the matching error with the matched blocks. Both methods are entirely equivalent in operating logic and final results. Accordingly, the present invention is described only in terms of the first method to avoid redundancy.

In decoding method and apparatus of the present invention, the basic distinctive technical feature is that in matching block copying and pasting (the value of the said decoding block is directly or indirectly set equal to the value of the said matching block) of block matching decoding for the current decoding block, the said matching blocks are not necessarily located in the reconstructed reference pixel sample set, that is, can contain non-reconstructed part. For the matching block containing the non-reconstructed part, firstly the non-reconstructed part of the said matching block must be filled by using some pixel samples inside or near the reconstructed part of the said matching block or by using other pixel samples obtained by a predetermined way, and then the complete matching blocks after filling non-reconstructed part is copied and pasted into the position of the current CU (i.e. matched block). Equivalently, these two operations of the said filling non-reconstructed part and coping and pasting can also be combined into a single step to complete, that is, the pixel samples to be used for filling the non-reconstructed part use a single step to copy and paste into (i.e. be directly or indirectly assigned to) the matched blocks. Both methods are entirely equivalent in operating logic and final results. Accordingly, the present invention is described only in terms of the first method to avoid redundancy.

In both encoding and decoding method and apparatus of the present invention, the basic distinctive technical feature is that in block matching encoding and decoding, matching block can contain non-reconstructed part. For the matching block containing the non-reconstructed part, i.e. partially reconstructed matching block, firstly the non-reconstructed part of the said matching block must be filled by using some pixel samples inside or near the reconstructed part of the said matching block or by using other pixel samples obtained by a predetermined way, that is, the values of some pixel samples inside or near the reconstructed part of the said matching block or other pixel samples obtained by a predetermined way are directly or indirectly assigned to non-reconstructed part of the said matching block, and then the other follow-up operations are conducted for encoding and decoding.

As previously said, the reconstructed part of a matching block has four cases. In these four cases, the non-reconstructed part of the said matching block can be filled (i.e. directly or indirectly assigned to) by using some suitable manner. When block is line (i.e., the block with height or width of 1 sample), matching block becomes matching strip, and these four cases of the reconstructed part also become two cases. When block is string (pixel samples within block are arranged into a string for which the length is much greater than the width), matching block becomes matching string, and these four cases of the reconstructed part also becomes one case.

In the case that the reconstructed part of a matching block or a matching strip with width of 1 is the top part of the matching block or the matching strip with width of 1 (case 1 of FIG. 9), if the reconstructed part is greater than the non-reconstructed part, several rows of pixel samples selected from the top reconstructed part are used to fill (i.e. be directly or indirectly assigned to) the bottom non-reconstructed part. Several rows from the top part can be any pre-agreed (to ensure that the consistency and correctness of coder and decoder) plurality of rows, such as the top-most several rows of the reconstructed part or the lowest several rows of the reconstructed part. If the reconstructed part is less than the non-reconstructed part, several rows of pixel samples selected from the top reconstructed part are repeatedly used to fill (i.e. be directly or indirectly assigned to) the bottom non-reconstructed part repeatedly. The said several rows from the top reconstructed part can be all rows of the top reconstructed part, and can also be partial rows of the top reconstructed part. The rules to select rows must be pre-agreed to ensure the consistency and correctness of encoder and decoder. In summary, the way of the said filling the non-reconstructed part is that some or all of pixel samples are copied from the reconstructed part of matching block or matching strip with width of 1 and are used to paste and fill the non-reconstructed part of matching block or matching strip with width of 1 from top to bottom (i.e. the vertical direction), i.e., the values of some or all of pixel samples from the reconstructed part of matching block or matching strip with width of 1 are directly or indirectly assigned to the non-reconstructed part of matching block or matching strip with width of 1 from top to bottom (i.e. the vertical direction).

In the case that the reconstructed part of a matching block or a matching strip with width of 1 is the left part of the matching block or the matching strip with width of 1 (case 2 of FIG. 9), if the reconstructed part is greater than the non-reconstructed part, several columns of pixel samples selected from the left reconstructed part are used to fill (i.e. be directly or indirectly assigned to) the right non-reconstructed part. Several columns from the left part can be any pre-agreed (to ensure that the consistency and correctness of coder and decoder) plurality of columns, such as the left-most several columns of the reconstructed part or the right-most several columns of the reconstructed part. If the reconstructed part is less than the non-reconstructed part, several columns of pixel samples selected from the left reconstructed part are repeatedly used to fill (i.e. be directly or indirectly assigned to) the right non-reconstructed part repeatedly. The said several columns from the left reconstructed part can be all columns of the left reconstructed part, and can also be partial columns of the left reconstructed part. The rules to select columns must be pre-agreed to ensure the consistency and correctness of coder and decoder. In summary, the way of the said filling the non-reconstructed part is that some or all of pixel samples are copied from the reconstructed part of matching block or matching strip with width of 1 and are used to paste and fill the non-reconstructed part of matching block or matching strip with width of 1 from left to right (i.e. the horizontal direction), i.e. the values of some or all of pixel samples from the reconstructed part of matching block or matching strip with width of 1 are directly or indirectly assigned to the non-reconstructed part of matching block or matching strip with width of 1 from left to right (i.e. the horizontal direction).

In the case that the reconstructed part of a matching block is the top-left part of the matching block (case 3 of FIG. 10), the process of filling (i.e. assignment of) the non-reconstructed part can be divided into two steps. In the first step, several rows of reconstructed pixel samples from the top-left reconstructed part are used one or more times to fill (i.e. be directly or indirectly assigned to) the bottom-left non-reconstructed part. In the second step, several columns of reconstructed pixel samples from the left reconstructed part and the filled (i.e. assigned) non-reconstructed part are used one or more times to fill (i.e. be directly or indirectly assigned to) the right non-reconstructed part. Another equivalent approach is also used. That is, in the first step, several columns of reconstructed pixel samples from the top-left reconstructed part are used one or more times to fill (i.e. be directly or indirectly assigned to) the top-right reconstructed part. In the second step, several rows of reconstructed pixel samples from the top reconstructed part and the filled (i.e., assigned) non-reconstructed part are used one or more times to fill (i.e. be directly or indirectly assigned to) the bottom non-reconstructed part. In summary, the way of the said filling the non-reconstructed part is that partial pixel samples are copied from the reconstructed part of matching block and are used to paste and fill the non-reconstructed part of matching block firstly from top to bottom (i.e. the vertical direction) and then from left to right (i.e. the horizontal direction), or equivalently, firstly from left to right (i.e. the horizontal direction) and then from top to bottom (i.e. the vertical direction). That is, the values of some or all of pixel samples from the reconstructed part of matching block are directly or indirectly assigned to the non-reconstructed part of matching block firstly from top to bottom (i.e. the vertical direction) and then from left to right (i.e. the horizontal direction), or equivalently, firstly from left to right (i.e. the horizontal direction) and then from top to bottom (i.e. the vertical direction).

In the case that the reconstructed part of a matching block is the part of the matching block with the bottom-right part removed, that is, the non-reconstructed part is the bottom-right part (case 4 of FIG. 10), the reconstructed part is Γ-shape consisting of two rectangles called the left rectangle and the right rectangle respectively. The general approach of filling (i.e. assignment of) the non-reconstructed part is that several Γ-shape pixel samples from the Γ-shape reconstructed part are used one or more times to fill (i.e. be directly or indirectly assigned to) the bottom-right non-reconstructed part. If the Γ-shape pixel samples used one time are not sufficient to fill (i.e. be assigned to) the entire bottom-right non-reconstructed part, they are used several times to repeatedly fill (i.e. be assigned to) the bottom-right non-reconstructed part. A special case of the said general approach is that the Γ-shape pixel samples used are degenerated into a rectangle located in the left rectangle to fill (i.e. be directly or indirectly assigned to) the bottom-right non-reconstructed part. Another special case of the said general approach is that the Γ-shape pixel samples used are degenerated into a rectangle located in the right rectangle to fill (i.e. be directly or indirectly assigned to) the bottom-right non-reconstructed part. In summary, the way of the said filling the non-reconstructed part is that partial pixel samples are copied from the reconstructed part of matching block and are used to paste and fill the non-reconstructed part of matching block from top-left to bottom-right (i.e. in the 45° direction) or from left to right (i.e. in the horizontal direction) or from top to bottom (i.e. in the vertical direction), that is, the values of some or all of pixel samples from the reconstructed part of matching block are directly or indirectly assigned to the non-reconstructed part of matching block from top-left to bottom-right (i.e. in the 45° direction) or from left to right (i.e. in the horizontal direction) or from top to bottom (i.e. in the vertical direction).

The reconstructed part of a partially reconstructed match string is usually the front part of the matching string. If the reconstructed part is larger than the non-reconstructed part, several pixel samples selected from the front reconstructed part can be used to fill (i.e. be directly or indirectly assigned to) the back non-reconstructed part. Several pixel samples from the front part can be any pre-agreed (to ensure that the consistency and correctness of encoder and decoder) plurality of pixel samples, such as the foremost of several pixel samples or the rearmost of several pixel samples of the reconstructed part. If the reconstructed part is less than the non-reconstructed part, several pixel samples selected from the front reconstructed part are repeatedly used to fill (i.e. be directly or indirectly assigned to) the back non-reconstructed part repeatedly. The said several pixel samples selected from the front reconstructed part can be all pixel samples of the front reconstructed part, and can also be partial pixel samples of the front reconstructed part. The rules to select must be pre-agreed to ensure the consistency and correctness of encoder and decoder. In summary, the way of the said filling the non-reconstructed part is that some or all of pixel samples are copied from the reconstructed part of matching string and are used to paste and fill the non-reconstructed part of matching string from front to back, that is, the values of some or all of pixel samples from the reconstructed part of matching string are directly or indirectly assigned to the reconstructed part of matching string from front to back.

A large class of partially reconstructed matching blocks is the one that the matching block is in a position overlapping the matched block. A partially reconstructed matching block of this special class is called a matching block connected with a matched block, and also called a matching block partially matched with itself, or called for short a matching block of partially self-matching or partially self-matching block. For the five pairs of matching block and matched block shown in FIG. 7, four are partially self-matching cases, and one is not partially self-matching case. For the six pairs of matching block and matched block shown in FIG. 8, five are partially self-matching cases, and one is not partially self-matching case.

Let (Xc, Yc) be the most top-left pixel sample coordinates of a matched block with width of Nx and height of Ny, and (Xr, Yr) are the most top-left pixel sample coordinates of a matching block (must have the same width and height with the matched block). According to the plane analytic geometry knowledge, the matching block intersected with matched block is equivalent to matching blocks satisfying the following relationships: |Xr−Xc|<Nx and |Yr−Yc|<Ny. In addition, according to the encoding or decoding order, Xr≧Xc and Yr≧Yc will never be satisfied simultaneously.

Coordinates (Xc, Yc) and (Xr, Yr) have the following relations with the above four cases and can be used as sufficient conditions to judge the reconstructed part of matching block belonging to which cases:
1) If Xr≧Xc and Yc−Ny<Yr<Yc are satisfied simultaneously, and the top-right area outside of the current matched block is in the reconstructed reference pixel sample set, then belonging to case 1).
2) If Xc−Nx<Xr<Xc and Yr≧Yc are satisfied simultaneously, and the bottom-left area outside of the current matched block is in the reconstructed reference pixel sample set, then belonging to case 2).
3) If Xr≧Xc and Yc−Ny<Yr<Yc are satisfied simultaneously but the top-right area outside of the current matched block is not in the reconstructed reference pixel sample set, or Xc−Nx<Xr<Xc and Yr≧Yc are satisfied simultaneously but the bottom-left area outside of the current matched block is not in the reconstructed reference pixel sample set, then belonging to case 3).
4) If Xc−Nx<Xr<Xc and Yc−Ny<Yr<Yc are established simultaneously, then belonging to case 4).

The above several specific examples illustrate the technical features of the present invention. The technical staff of the field can easily understand other advantages and efficacy of the present invention from the disclosure of this specification. The present invention can also be implemented or applied through other various specific implementations and embodiments. The details of the specification can be also modified or changed based on different perspectives and applications without departing from the spirit of the present invention. Other names of the matching block include but are not limited to the reference block, prediction block in the present invention. In the process of encoding, other names of the matched block include but are not limited to the original block, the current block, the current encoding block in the present invention. In the process of decoding and reconstructing, other names of the matched block include but are not limited to the constructed block, the reconstructed block, the current block, the current decoding block in the present invention.

A flow chart showing the steps performed by an embodiment of the encoding method process of the present invention is shown in FIG. 11. The encoding method of the present invention includes but is not limited to some or all of the following steps:
1) Input the position and size of a current matched block and the positions and sizes of several candidate matching blocks in a predetermined search range. For the said matched block and each matching block of said several candidate matching blocks, the following steps are performed: whether or not the said matching block is entirely in the reconstructed reference pixel sample buffer is determined based on the position and size of the matched block and the position and size of the matching block, if yes, go to the next step, otherwise, go to step 3).
2) Select the original completely reconstructed matching block from the said reconstructed reference pixel sample buffer as the input matching block of the motion vector searching in the subsequent step 5). Go to step 5).
3) For the partially reconstructed matching block, the non-reconstructed part of the said partially reconstructed matching block is filled by using all or part of reconstructed pixel samples inside the said partially reconstructed matching block and/or reconstructed pixel samples near the said partially reconstructed matching block, that is, the values of all or part of reconstructed pixel samples inside the said partially reconstructed matching block and/or reconstructed pixel samples near the said partially reconstructed matching block are directly or indirectly assigned to the non-reconstructed part of the said partially reconstructed matching block, resulting in the filled and reconstructed matching block. Go to the next step.
4) The said filled and reconstructed matching block is selected as the input matching block of the motion vector searching in the subsequent step 5). Go to the next step.
5) Using the said matching block (i.e. the input matching block of step 2 or the input matching block of step 4) as a reference and candidate, the motion vector searching is performed for the said matched block to find the best matching block and the optimal motion vector. Also perform the rest steps of encoding.

A flow chart showing the steps performed by an embodiment of the decoding method process of the present invention is shown in FIG. 12. The decoding method of the present invention includes but is not limited to some or all of the following steps:
1) Based on the motion vector (i.e. the optimal motion vector found in searching by the encoder) derived from the input compressed video stream, whether or not the corresponding matching block of the matched block in the current decoding position is entirely in the reconstructed reference pixel sample buffer is determined, if yes, go to the next step, otherwise, go to step 3).
2) Select the original completely reconstructed matching block from the said reconstructed reference pixel sample buffer as the matching block to be copied in the subsequent step 5). Go to step 5).
3) For the partially reconstructed matching block, the non-reconstructed part of the said partially reconstructed matching block is filled by using all or part of reconstructed pixel samples inside the said partially reconstructed matching block and/or reconstructed pixel samples near the said partially reconstructed matching block, that is, the values of all or part of reconstructed pixel samples inside the said partially reconstructed matching block and/or reconstructed pixel samples near the said partially reconstructed matching block are directly or indirectly assigned to the non-reconstructed part of the said partially reconstructed matching block, resulting in the filled and reconstructed matching block. Go to the next step.
4) The said filled and reconstructed matching block is selected as the matching block to be copied in the subsequent step 5). Go to the next step.
5) The said matching block (i.e. the matching block of step 2 or the matching block of step 4) is copied and pasted into the position of the said matched block, that is, the value of the said matching block is directly or indirectly assigned to the said matched block. Also perform the rest steps of decoding.

A block diagram showing the modules in an embodiment of the encoding apparatus of the present invention is shown in FIG. 13. The encoding apparatus includes but is not limited to all or part of the following modules:
1) The module to determine whether or not a matching block is entirely in the reconstructed reference pixel sample storage buffer module. The module input includes the position and size of a current matched block. The module input further includes the position and size of a candidate matching block in a predetermined search range. The module determines whether or not the said matching block is entirely in the reconstructed reference pixel sample storage buffer module based on the position and size of the said matched block and the position and size of the said matching block.
2) The reconstructed reference pixel sample storage buffer module. Previously reconstructed pixel samples within a predetermined search (reference) range and before the current matched block pixel position are stored and used as the reference pixel samples (i.e. the candidate matching block pixel samples) of the current matched block being encoded.
3) The module to use reconstructed part to fill (i.e. be assigned to) non-reconstructed part (i.e. to build non-reconstructed part). For a partially reconstructed matching block, the non-reconstructed part of the said partially reconstructed matching block is filled by using all or part of reconstructed pixel samples inside the said partially reconstructed matching block and/or reconstructed pixel samples near the said partially reconstructed matching block, that is, the values of all or part of reconstructed pixel samples inside the said partially reconstructed matching block and/or reconstructed pixel samples near the said partially reconstructed matching block are directly or indirectly assigned to the non-reconstructed part of the said partially reconstructed matching block, resulting in the filled and reconstructed matching block.
4) The motion vector searching module. The function of the module is that for an input current matched block, in a predetermined search range of the reconstructed reference pixel sample set, i.e. the said reconstructed reference pixel sample storage buffer module, according to a predetermined evaluation criteria, a best matching block and its corresponding optimum motion vector are searched and obtained. The said best matching block can be a original completely reconstructed matching block of the said reconstructed reference pixel sample storage buffer module or a filled and reconstructed matching block from the said module to use reconstructed part to fill non-reconstructed part.
5) Module for the rest of encoding operation. Perform the rest of encoding operations for the current matched block, the current CU, and the current LCU.

A block diagram showing the modules in an embodiment of the decoding apparatus of the present invention is shown in FIG. 14. The decoding apparatus includes but is not limited to all or part of the following modules:
1) The module to determine whether or not a matching block is entirely in the reconstructed reference pixel sample storage buffer module. The module input includes but is not limited to the motion vector derived from the input video bitstream. The module determines whether or not the matching block corresponding to the said motion vector is entirely in the reconstructed reference pixel sample storage buffer module based on the said motion vector and the position and size of the matched block being decoded.
2) The reconstructed reference pixel sample storage buffer module. Previously reconstructed pixel samples within a predetermined reference range and before the current matched block pixel position are stored and used as the reference pixel samples (i.e. the said matching block pixel samples) of the current matched block being decoded.
3) The module to use reconstructed part to fill (i.e. be assigned to) non-reconstructed part (i.e. to build non-reconstructed part). For a partially reconstructed matching block specified by the said motion vector, the non-reconstructed part of the said partially reconstructed matching block is filled by using all or part of reconstructed pixel samples inside the said partially reconstructed matching block and/or reconstructed pixel samples near the said partially reconstructed matching block, that is, the values of all or part of reconstructed pixel samples inside the said partially reconstructed matching block and/or reconstructed pixel samples near the said partially reconstructed matching block are directly or indirectly assigned to the non-reconstructed part of the said partially reconstructed matching block resulting in the filled and reconstructed matching block.
4) Module to copy the matching block and paste it into the position of the matched block (that is, to assign the values of the matching block to the matched block). The function of this module is to copy either the original completely reconstructed matching block or the filled and reconstructed matching block generated in module 3) from the position in the said reconstructed reference pixel sample storage buffer module and specified by the motion vector, and to paste the matching block into the position of the matched block being decoded, that is, to directly or indirectly assign either the values of the original completely reconstructed matching block or the filled and reconstructed matching block to the said matched block being decoded.
5) The module for the rest of decoding operation. Perform the rest of decoding operations for the current matched block, the current CU, and the current LCU.

The above provided examples only illustratively show the basic idea of the invention, and the illustrations only show the components directly related with the present invention and are not drawn in terms of the real number, shape and size of components. When the invention is actually implemented, the type, number and proportion of the various components can be arbitrarily changed, and the component layout patterns may also be more complex.

The followings are more embodiment details and variants of the present invention.

The decoding method of the present invention can equivalently include but be not limited to a portion or entire of the following steps that have the same final technical effect:
1) Based on the motion vector (i.e., the optimal motion vector found in searching by the encoder) derived from the input compressed video stream, whether or not the corresponding matching block of the matched block in the current decoding position is entirely in the reconstructed reference pixel sample buffer is determined, if yes, go to the next step, otherwise, go to step 3).
2) The original completely reconstructed matching block is copied from the said reconstructed reference pixel sample buffer and pasted into the position of the said matched block, that is, the values of the said original completely reconstructed matching block are directly or indirectly assigned to the said matched blocks. Go to step 5).
3) The reconstructed pixel samples of the partially reconstructed matching block are copied from the said reconstructed reference pixel sample buffer and pasted into the position of the said matched block, that is, the values of the said reconstructed pixel sample are directly or indirectly assigned to the corresponding part of the said matched blocks.
4) All or part of the said reconstructed pixel samples or the reconstructed pixel samples near the said partially reconstructed matching block are directly pasted into the position which is not pasted into by the above step 3) in the said matched block to fill the entire matched block, that is, the values of all or part of the said reconstructed pixel samples or the reconstructed pixel samples near the said partially reconstructed matching block are directly or indirectly assigned to the position which is not pasted into by the above step 3 in the said matched block to complete all assignments of the entire matched block.
5) The rest steps of decoding are performed.

The decoding apparatus of the present invention can equivalently include but be not limited to a portion or entire of the following modules that have the same final technical effect:
1) The module to determine whether or not a matching block is entirely in the reconstructed reference pixel sample storage buffer module. The module input includes but is not limited to the motion vector derived from the input video bitstream. The module determines whether or not the matching block corresponding to the said motion vector is entirely in the reconstructed reference pixel sample storage buffer module based on the said motion vector and the position and size of the matched block being decoded.
2) The reconstructed reference pixel sample storage buffer module. Previously reconstructed pixel samples within a predetermined reference range and before the current matched block pixel position are stored and used as the reference pixel samples of the current matched block being decoded.
3) Module to copy and paste the original completely reconstructed matching block into the position of the matched block (that is, the values of the original completely reconstructed matching block are assigned to matched block). The function of this module is that the original completely reconstructed matching block is copied from the position specified by the said motion vector and in the said reconstructed reference pixel sample buffer module, and pasted into the position of the matched block being decoded, that is, the values of the original completely reconstructed matching block are directly or indirectly assigned to the matched block being decoded.
4) Module to copy and paste the partially reconstructed matching block into the position of the matched block (that is, the values of the partially reconstructed matching block are assigned to matched block). The function of the module is that the reconstructed pixel samples of the partially reconstructed matching block are copied from the position specified by the said motion vector and in the said reconstructed reference pixel sample buffer module, firstly the said reconstructed pixel samples are pasted into the corresponding position of the said matched block, and then all or part of the said reconstructed pixel samples and/or the reconstructed pixel samples near the said partially reconstructed matching block are further pasted into the position that is not yet pasted into in the said matched block to fill the whole matched block, that is, firstly the said reconstructed pixel samples values are directly or indirectly assigned to the corresponding position of the said matched block, and then all or part of the said reconstructed pixel samples and/or the reconstructed pixel samples near the said partially reconstructed matching block are directly or indirectly assigned to the position which is not yet assigned into in the said matched block to complete all assignments of the whole matched block.
5) The module for the rest of decoding operation. Perform the rest of decoding operations for the current matched block, the current CU, and the current LCU.

Partially reconstructed matching block includes but is not limited to the matching block of satisfying |Xr−Xc|<Nx and |Yr−Yc|<Ny, i.e. the matching block intersected with matched block, also called the matching block of partially self-matching, the corresponding matched block is called the matched block of partially self-matching. This is a class of the most common partially reconstructed matching block.

In the case of partially self-matching, a method in which the matched block is assigned to by the values of the matching block pixel samples is that firstly, all values of the reconstructed part of the said matching block are directly or indirectly assigned to the corresponding position of the said matched block, if there is still unassigned part in the matched block, all values of the reconstructed part of the said matching block are directly or indirectly assigned to the unassigned part in the said matched block repeatedly until the said matched block are completely assigned. This assignment method in which the matched block is directly or indirectly assigned to by all values of the reconstructed part of the said matching block fully and repeatedly is called complete assignment method of partially self-matching.

Partially self-matching has a special situation where the non-reconstructed part of the partially reconstructed matching block is entirely and completely in the corresponding matched block. The special situation is called Γ-shape partially self-matching. There are two special situations in Γ-shape partially self-matching: the vertical partially self-matching (i.e. Xr=Xc and Yc−Ny<Yr<Yc) and the horizontal partially self-matching (i.e. Xc−Nx<Xr<Xc and Yr=Yc)

Γ-shape partially self-matching is equivalent to that Xc−Nx<Xr≦Xc and Yc−Ny<Yr≦Yc hold simultaneously, but two equal signs do not hold at the same time. Note that the simultaneous holding of two equal signs (Xr=Xc and Yr=Yc) means the matching block completely equal to matched block, while such matching block does not exist. Complete assignment method of Γ-shape partially self-matching can use (but is not limited to) any of the following assignments or their combination to accomplish:

Assignment statement 1 of complete assignment method of Γ-shape partially self-matching

for (y=0; y<Ny; ++y)

for (x=0; x<Nx; ++x)

P(Xc+x,Yc+y)=P(Xr+x,Yr+y)

Assignment statement 2 of complete assignment method of Γ-shape partially self-matching

for (y=0; y<Ny; ++y)

for (x=0; x<Nx; ++x)

P(Xc+Nx−1−x,Yc+y)=P(Xr+Nx−1−x,Yr+y)

Assignment statement 3 of complete assignment method of Γ-shape partially self-matching

for (x=0; x<Nx; ++x)

for (y=0; y<Ny; ++y)

P(Xc+x,Yc+y)=P(Xr+x,Yr+y)

Assignment statement 4 of complete assignment method of Γ-shape partially self-matching

for (x=0; x<Nx; ++x)

for (y=0; y<Ny; ++y)

P(Xc+x,Yc+Ny−1−y)=P(Xr+x,Yr+Ny−1−y)

It can be seen that: the assignment statements 1, 2, 3, 4 for the complete assignment method of Γ-shape partially self-matching block have the same format as the assignment statement 1, 2, 5, 7 of the original completely reconstructed matching block. But they are essentially different in that they have completely different applicable scope: in the case of the original completely reconstructed matching block, the relation |Xr−Xc|≧Nx or |Yr−Yc|≧Ny must be satisfied, while in the case of the complete assignment method of Γ-shape partially self-matching block, the relation Xc−Nx<Xr≦Xc and Yc−Ny<Yr≦Yc must be satisfied simultaneously, but two equal signs cannot be satisfied simultaneously. Since both assignment statements are formally the same, the former is obviously the applicable scope expansion of the latter with the same assignment statement format.

A special class of partially reconstructed matching block is the matching block satisfying Xc−Nx<Xr<Xc and Yc−Ny<Yr<Yc, that is, the matching block is the one that intersects with the matched block and its reconstructed part has strict Γ-shape.

Another special class of partially reconstructed matching block is the matching block satisfying Xc−Nx<Xr≦Xc and Yc−Ny<Yr≦Yc, but two equal signs are not satisfied simultaneously, that is, the matching block intersecting with the matched block and the reconstructed part being degeneratable Γ-shape. The degenerated Γ-shape is the case of Xc−Nx<Xr<Xc and Yr=Yc or the case of Xr=Xc and Yc−Ny<Yr<Yc, i.e. the matching block and the matched block have horizontal displacement (the left-right partially self-matching) or vertical displacement (the top-bottom partially self-matching) relation.

One more special class of partially reconstructed matching block is the matching block satisfying Xc−Nx<Xr≦Xc−Nx/2 and Yc−Ny<Yr≦Yc−Ny/2, that is, the matching block is the one that intersects with the matched block and its reconstructed part is larger than three-quarters of the matching block.

In one variant of encoding and decoding method or apparatus of the present invention, when the non-reconstructed part of a partially reconstructed matching block is filled (i.e., directly or indirectly assigned to), a left adjacent rectangle consisting of the reconstructed pixel samples is used to fill the said non-reconstructed part as shown in FIG. 15, some or all of the reconstructed pixel samples of the said rectangle are allowed to be outside of the said partially reconstructed matching block.

In one variant of encoding and decoding method or apparatus of the present invention, when the non-reconstructed part of a partially reconstructed matching block is filled (i.e., directly or indirectly assigned to), a top adjacent rectangle consisting of the reconstructed pixel samples is used to fill the said non-reconstructed part as shown in FIG. 15, some or all of the reconstructed pixel samples of the said rectangle are allowed to be outside of the said partially reconstructed matching block.

In one variant of encoding and decoding method or apparatus of the present invention, when the non-reconstructed part of a partially reconstructed matching block is filled (i.e., directly or indirectly assigned to), one portion uses a left adjacent rectangle consisting of the reconstructed pixel samples to fill one portion of the said non-reconstructed part, and another portion uses a top adjacent rectangle consisting of the reconstructed pixel samples to fill another portion of the non-reconstructed part, and some or all of the reconstructed pixel samples of the said rectangles are allowed to be outside of the said partially reconstructed matching block.

In encoding and decoding method or apparatus of the present invention, the way of constructing or filling (i.e. directly or indirectly assigning to) the non-reconstructed part of a partially reconstructed matching block (reference block) includes but is not limited to one of the following ways or their combination:

All or part of the values of the said non-reconstructed part are set directly or indirectly equal to the values of a portion or entire of the reconstructed reference pixel samples within the said reconstructed part of the said reference block.
or
All or part of the values of the said non-reconstructed part are set directly or indirectly equal to the values obtained by performing extrapolation computation on the values of a portion or entire of the reconstructed reference pixel samples within the said reconstructed part of the said reference block according to a predetermined manner.
or
All or part of the values of the said non-reconstructed part are set directly or indirectly equal to the values of the adjacent reconstructed reference pixel samples outside the said reconstructed part of the said reference block.
or
All or part of the values of the said non-reconstructed part are set directly or indirectly equal to the values obtained by performing extrapolation computation on the values of a portion or entire of the adjacent reconstructed reference pixel samples outside the said reconstructed part of the said reference block according to a predetermined manner.
or
All or part of the values of the non-reconstructed part are set directly or indirectly equal to predetermined values.

In encoding and decoding method or apparatus of the present invention, the way to assign values to the part of a current block (matched block) corresponding to the non-reconstructed part of a reference block (matching block) includes but is not limited to one of the following ways or their combinations:

Values of a portion or entire of the reconstructed pixel samples within the reconstructed part of the said reference block are directly or indirectly assigned to the part of the said current block corresponding to the said non-reconstructed part of the said reference block.
or
Values obtained by performing extrapolation computation according to a predetermined manner on the values of a portion or entire of the reconstructed pixel samples within the reconstructed part of the said reference block are directly or indirectly assigned to the part of the said current block corresponding to the said non-reconstructed part of the said reference block.
or
Values of the adjacent reconstructed reference pixel samples outside the reconstructed part of the said reference block are directly or indirectly assigned to the part of the said current block corresponding to the said non-reconstructed part of the said reference block.
or
Values obtained by performing extrapolation computation according to a predetermined manner on the values of the adjacent reconstructed reference pixel samples outside the reconstructed part of the said reference block are directly or indirectly assigned to the part of the said current block corresponding to the said non-reconstructed part of the said reference block.
or
Predetermined values are directly or indirectly assigned to the part of the said current block corresponding to the said non-reconstructed part of the said reference block.

In encoding and decoding method or apparatus of the present invention, the operations of filling (i.e., directly or indirectly assigning to) the non-reconstructed part of a partially reconstructed matching block include but are not limited to extending reconstructed reference pixel samples set. The way of extending the reconstructed reference pixel sample set includes but is not limited to one of the following ways or their combination:

The pixel sample values of the extended part are set directly or indirectly equal to the values of a part of reconstructed reference pixel samples in the said reconstructed reference pixel sample set.

or

The pixel sample values of the extended part are set directly or indirectly equal to the values of a part of reconstructed reference pixel samples adjacent to the said extended part in the said reconstructed reference pixel samples set.

or

The pixel sample values of the extended part are set directly or indirectly equal to the values obtained by performing extrapolation computation according to a predetermined manner on a part of reconstructed reference pixel sample values in the said reconstructed reference pixel samples set.

or

The pixel sample values of the extended part are set directly or indirectly equal to the values obtained by performing extrapolation computation according to a predetermined manner on a part of reconstructed reference pixel sample values adjacent to the said extended part in the said reconstructed reference pixel samples set.

or

The pixel sample values of the extended part are set directly or indirectly equal to predetermined values.

or

All possible extended parts are filled by predetermined values.

Extension can be dynamic, constantly updated, and can also be static. Extended part is large enough to contain any possible non-reconstructed part of a possible partially reconstructed matching block. Thus, the values of any non-reconstructed part of a partially reconstructed matching block are set automatically equal to the pixel sample values of the extended part.

When the approach of extending reconstructed reference pixel sample set to form an extended part is used, in the process of assigning a partially reconstructed matching block directly or indirectly to a matched block, the two operations that firstly the reconstructed part of the said matching block is directly or indirectly assigned to the corresponding part of the said matched block and secondly the values of the said matching block pixel samples in the said extended part are directly or indirectly assigned to the rest unassigned part of the said matched block can actually be combined to complete: the said matching block (including the reconstructed part and the part of the pixel sample valuse in the extended part) is directly or indirectly assigned to the matched block.

In encoding and decoding method or apparatus of the present invention, when matching block is matching strip (i.e. the matching block with width of Nx=1 or height of Ny=1), the partial self-matching has only two situations:

1) The top-bottom partial self-matching, that is, the situation of Xr=Xc and Yc−Ny<Yr<Yc.

2) The left-right partial self-matching, that is, the situation of Xc−Nx<Xr<Xc and Yr=Yc.

Assignment statements of the complete assignment method of these two cases are (but not limited to):

Assignment statement of the complete assignment method of the top-bottom partial self-matching

for (y=0; y<Ny; ++y)

P(Xc,Yc+y)=P(Xr,Yr+y)

Assignment statement of the complete assignment method of the left-right partial self-matching

for (x=0; x<Nx; ++x)

P(Xc+x,Yc)=P(Xr+x,Yr)

It can be seen that:
1) The assignment statement for the complete assignment method of the top-bottom partial self-matching strip has the same format as the assignment statement 1 of the vertical original completely reconstructed matching strip, but they are essentially different in that they have completely different applicable scope: the former applies to the situation of Xr=Xc and Yc−Ny<Yr<Yc, while the latter applies to the situation of Xr being not equal to Xc or |Yr−Yc|≧Ny. Since both assignment statements are formally the same, the former is obviously the applicable scope extension of the latter with the same assignment statement format.
2) The assignment statement for the complete assignment method of the left-right partial self-matching strip has the same format as the assignment statement 1 of the horizontal original completely reconstructed matching strip, but they are essentially different in that they have completely different applicable scope: the former applies to the situation of Xc−Nx<Xr<Xc and Yr=Yc, while the latter applies to the situation of |Xr−Xc|≧Nx or Yr being not equal to Yc. Since both assignment statements are formally the same, the former is obviously the applicable scope extension of the latter with the same assignment statement format.

In encoding and decoding method or apparatus of the present invention, when the matching block is the matching string, the partial self-matching has only one case: front-rear partial self-matching, that is, the case of Kc−L<Kr<Kc. Assignment statement of the complete assignment method of the front-rear partial self-matching is

for (k=0; k<L; ++k)

P(Kc+k)=P(Kr+k)

It can be seen that: the assignment statement for the complete assignment method of the front-rear partial self-matching string has the same format as the assignment statement 1 of the original completely reconstructed matching string, but they are essentially different in that they have completely different applicable scope: the former applies to the situation of Kc−L<Kr<Kc, while the latter applies to the situation of Kc−Kr≧L. Since both assignment statements are formally the same, the former is obviously the applicable scope extension of the latter with the same assignment statement format.

FIG. 16 is one illustration of one embodiment of the complete assignment method of the left-right partial self-matching of the present invention. Matching strip and matched strip have 8 pixel samples each. In FIG. 16a, the reconstructed part of the partially reconstructed matching strip has 5 pixel samples, and the matched strip is cyclical duplicates of these 5 pixel samples. In FIG. 16b, the reconstructed part of the partially reconstructed matching strip has 3 pixel samples, and the matched strip is cyclical duplicates of these 3 pixel samples. In FIG. 16c, the reconstructed part of the partially reconstructed matching strip has 1 pixel sample, and the matched strip is cyclical duplicates of the 1 pixel sample.

### BRIEF DESCRIPTION OF THE DRAWINGS

FIG. 1 shows an example of all smallest sub-blocks numbered in a largest coding unit.

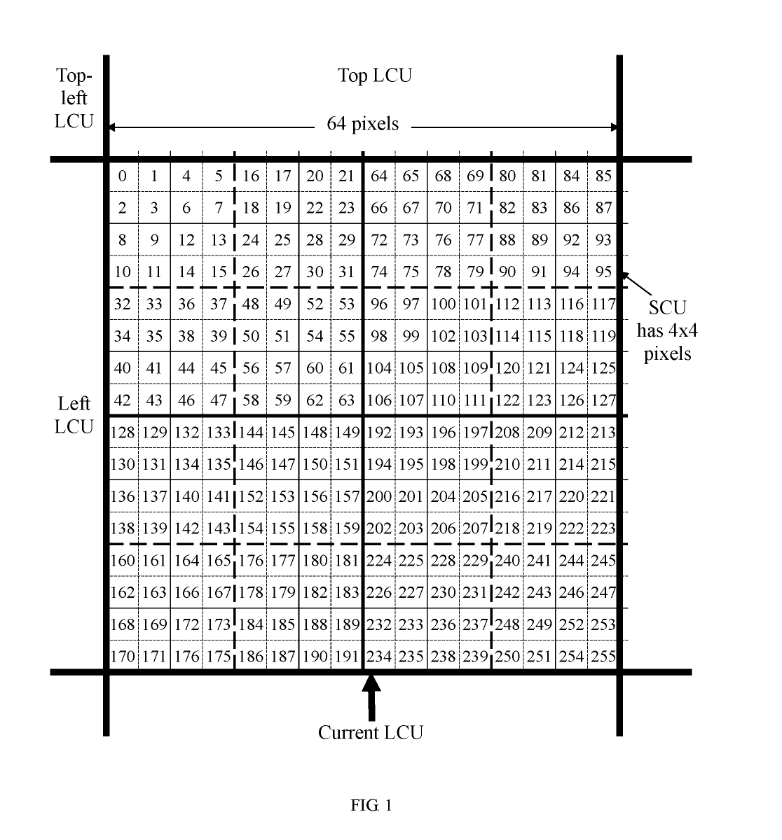

FIG. 2 shows an example of a current CU (matched block) and its reference block (matching block) in the reconstructed reference pixel sample set with the same square shape of 16×16 pixels in prior art.

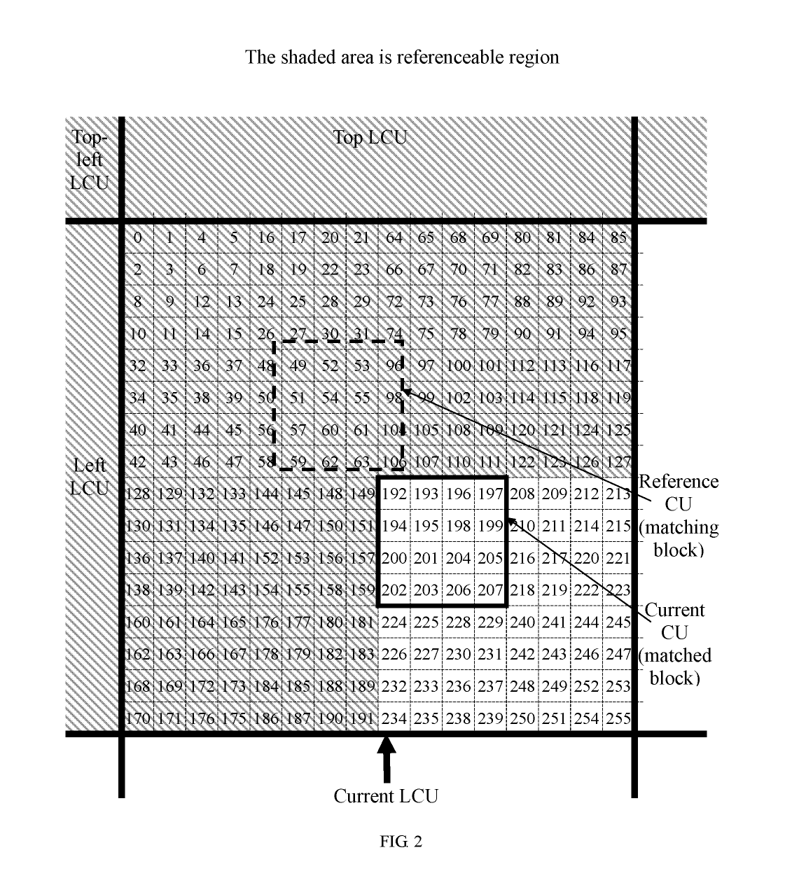

FIG. 3 shows an example of a current CU (matched block) and its reference block (matching block) in the reconstructed reference pixel sample set with the same square shape of 8×8 pixels in prior art.

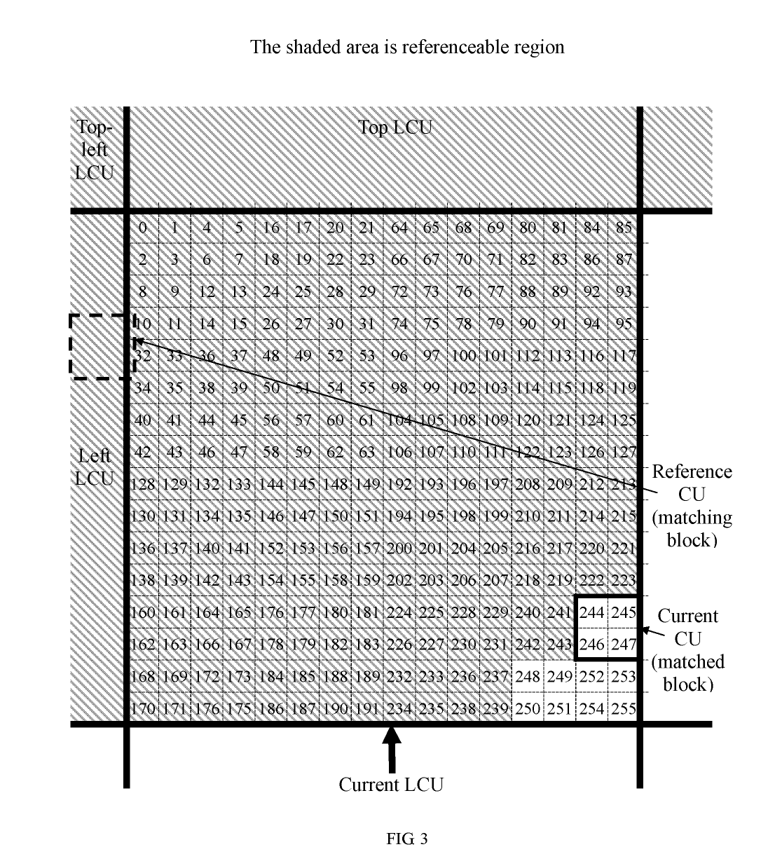

FIG. 4 shows an example of a current CU (matched block) and its reference block (matching block) in the reconstructed reference pixel sample set with the same square shape of 16×16 pixels in prior art.

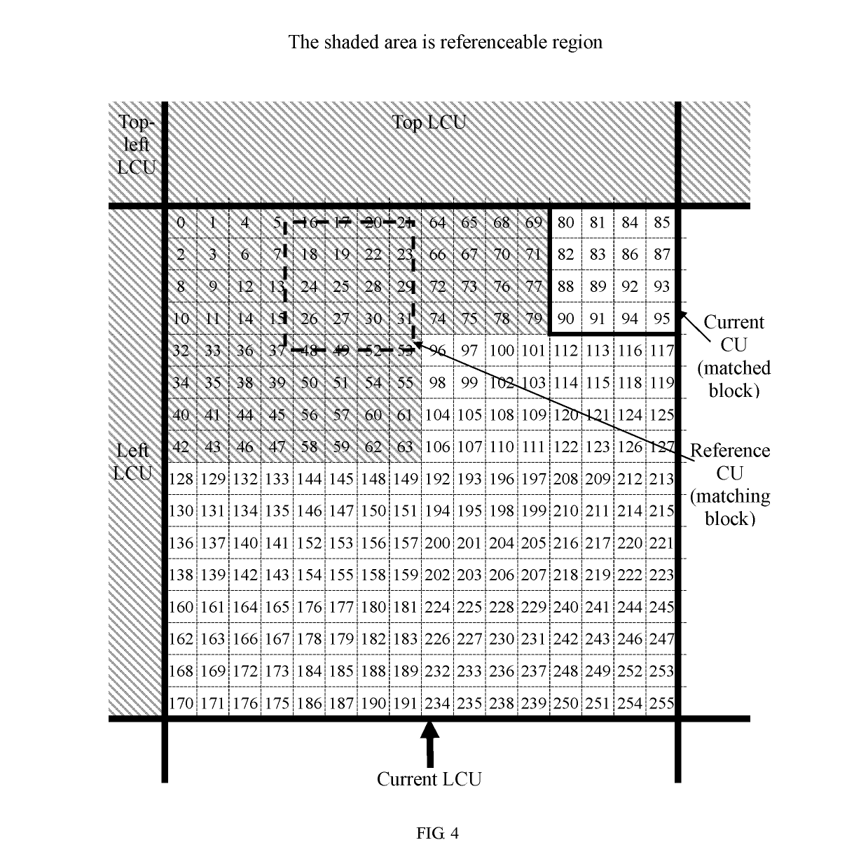

FIG. 5 shows an example of a current CU (matched block) and its reference block (matching block) in the reconstructed reference pixel sample set with the same square shape of 8×8 pixels in prior art.

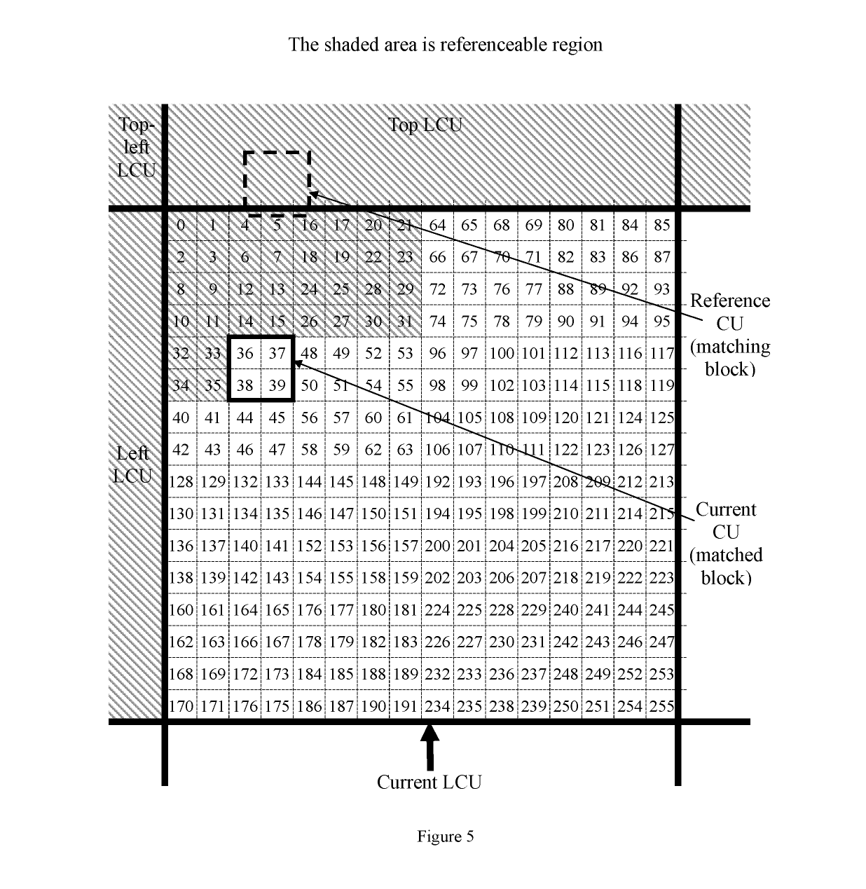

FIG. 6 shows an example of a current CU (matched block) and its reference block (matching block) in the reconstructed reference pixel sample set with the same square shape of 8×8 pixels in prior art.

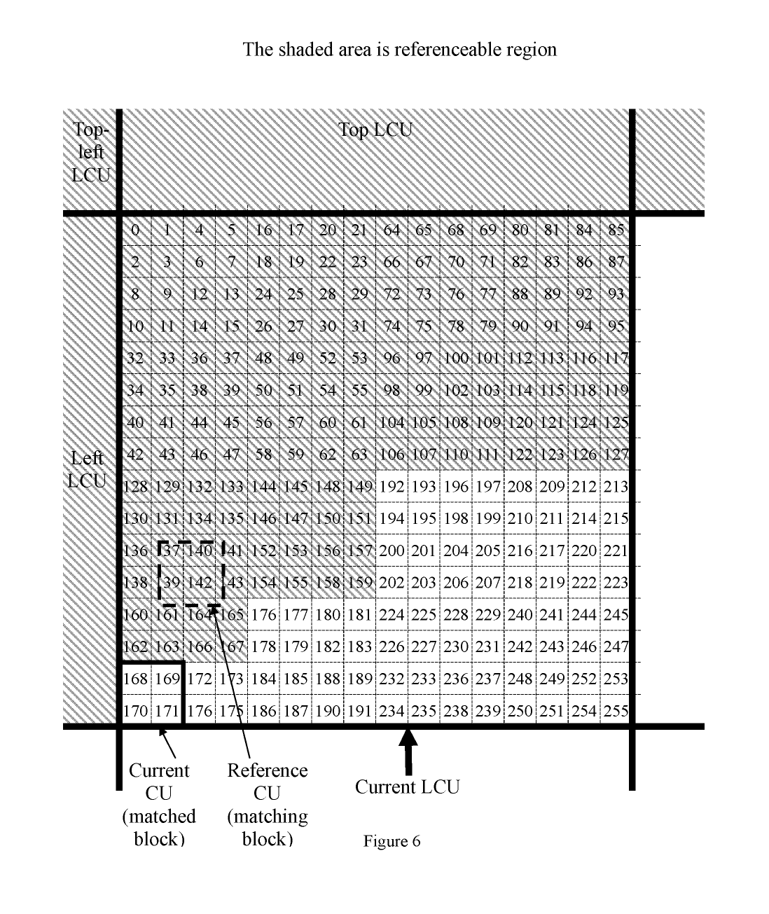

FIG. 7 shows four examples that only a portion rather than entire of the matching block locates in the reconstructed reference pixel samples set in the present invention.

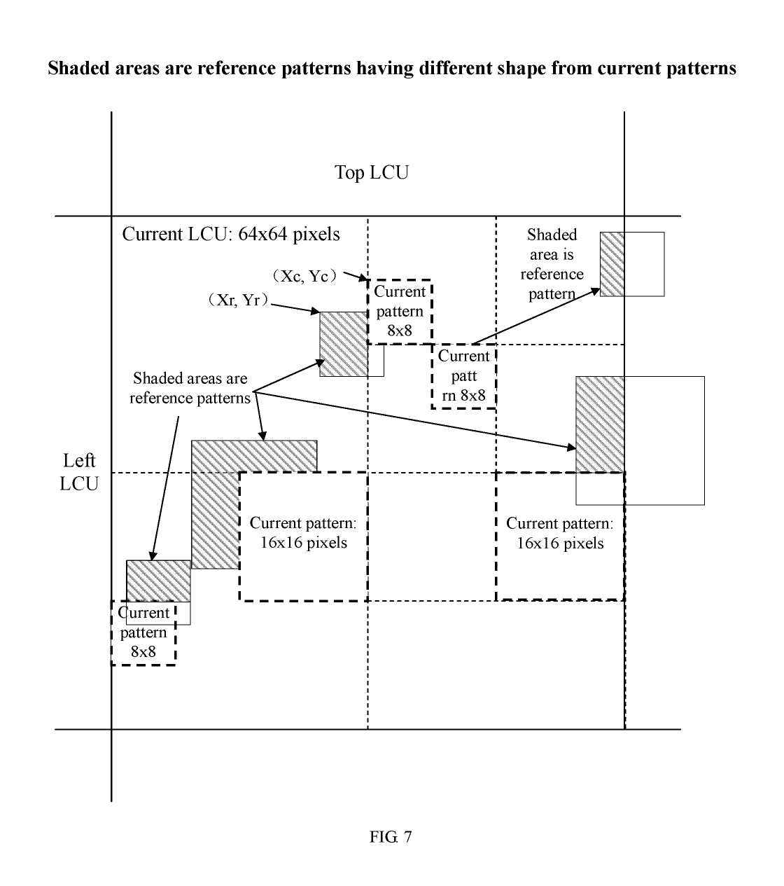

FIG. 8 shows six examples that only a portion rather than entire of the matching block locates in the reconstructed reference pixel samples set in the present invention.

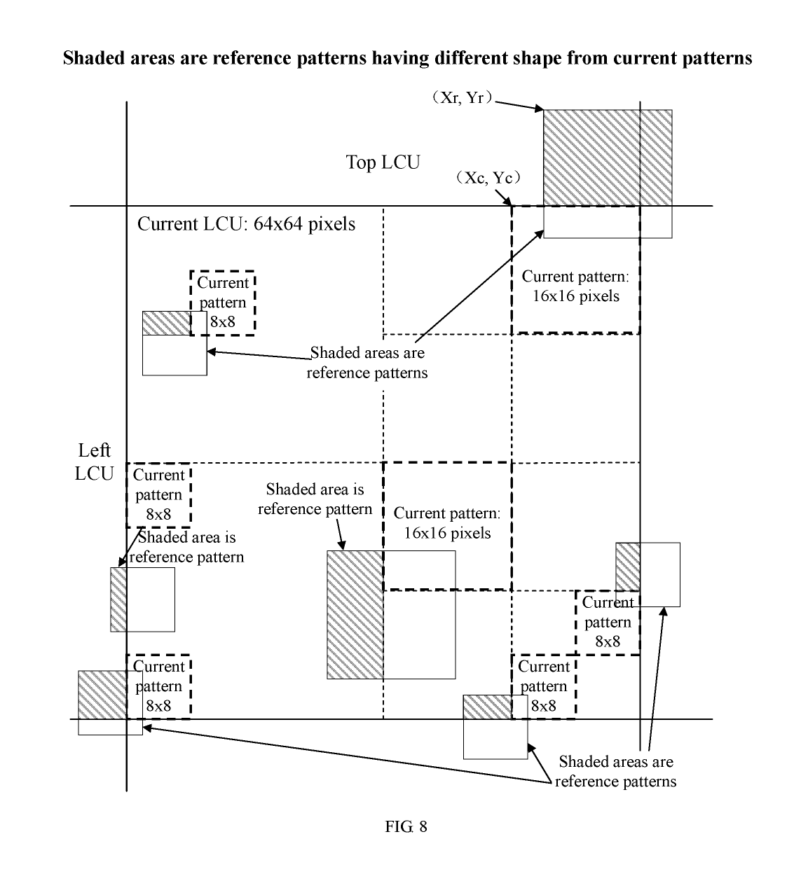

FIG. 9 shows four examples that a portion or entire of the first part of a current pattern provides reference pixels for the rest part of the current pattern in the present invention.

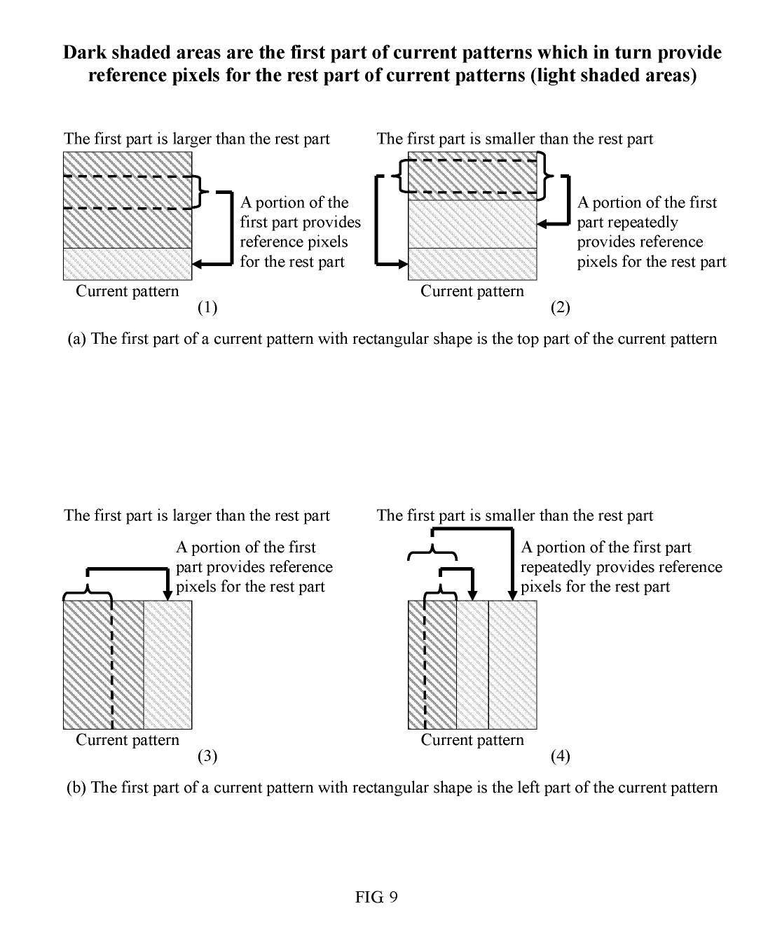

FIG. 10 shows five more examples that a portion or entire of the first part of a current pattern provides reference pixels for the rest part of the current pattern in the present invention.

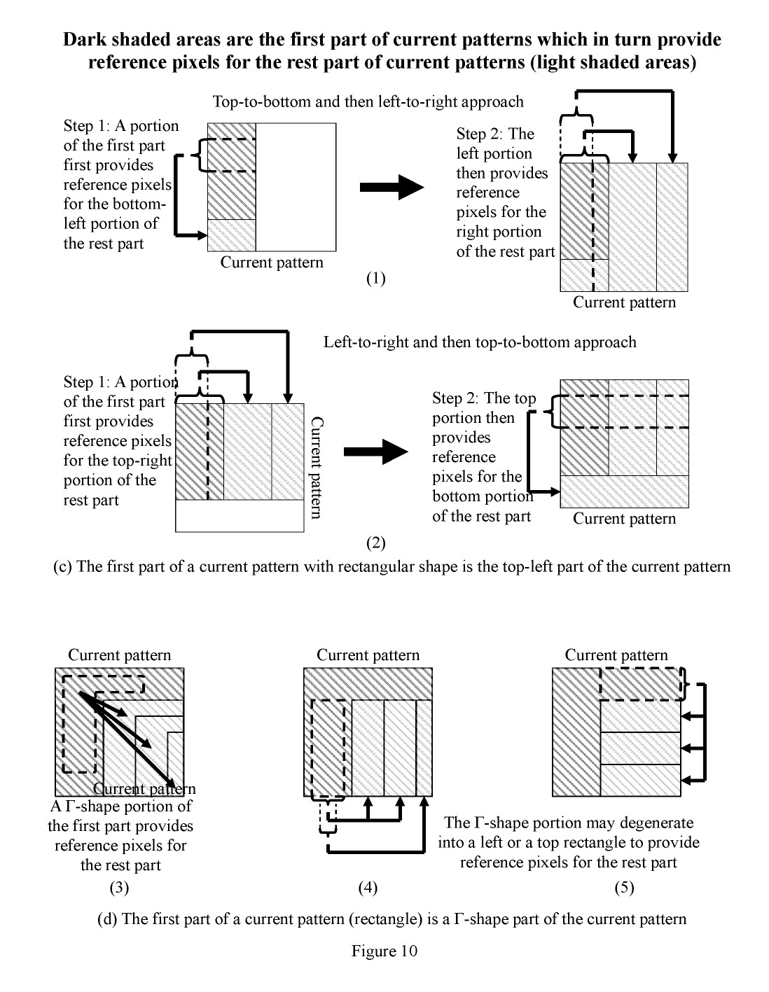

FIG. 11 is a flow chart showing the steps performed by an embodiment of the encoding method in the present invention

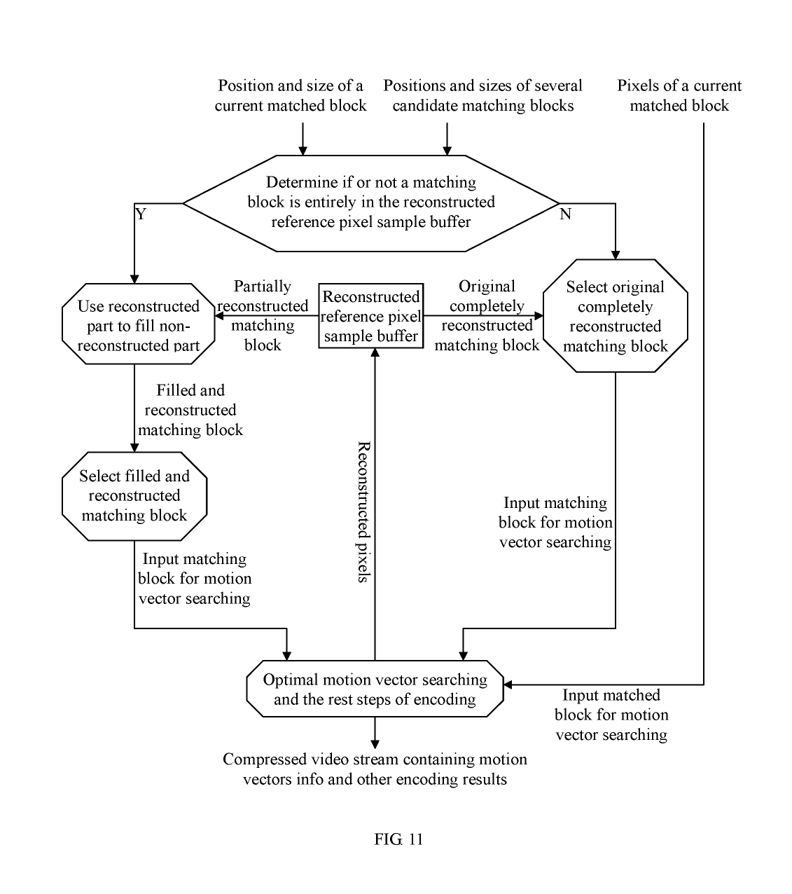

FIG. 12 is a flow chart showing the steps performed by an embodiment of the decoding method in the present invention

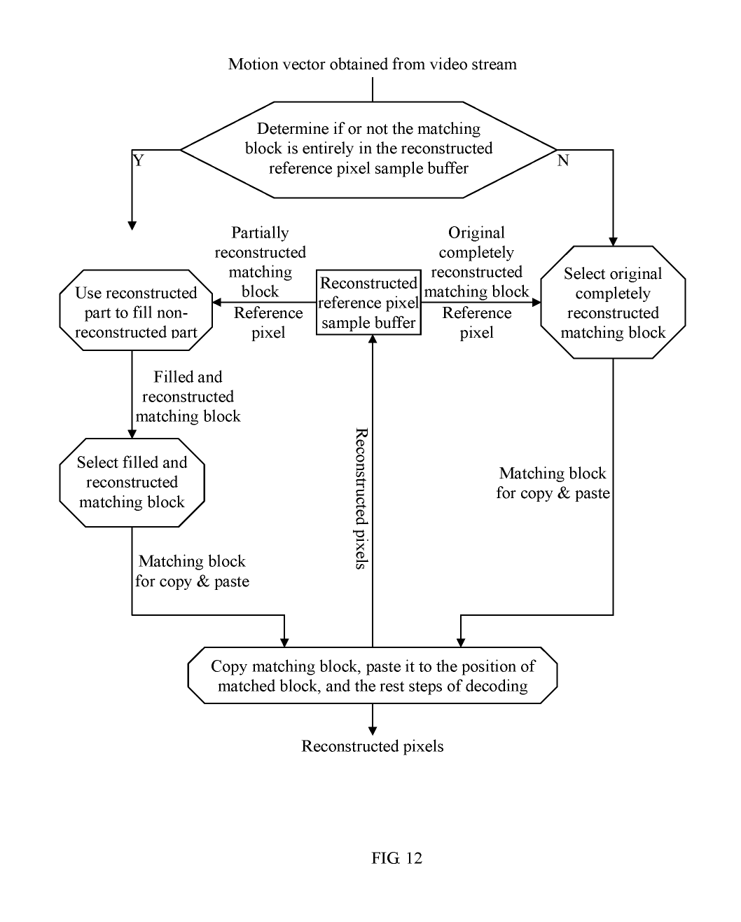

FIG. 13 is a block diagram showing the module in an embodiment of the encoding apparatus in the present invention

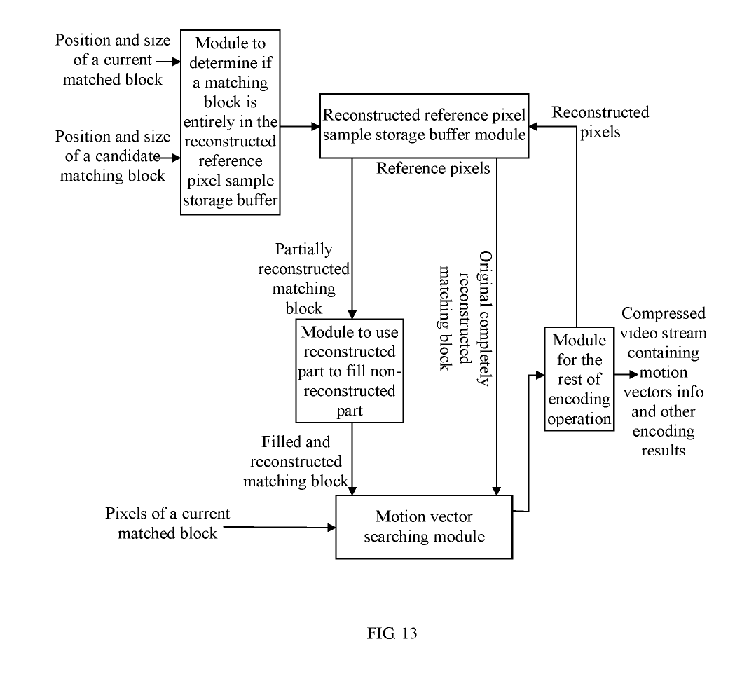

FIG. 14 is a block diagram showing the module in an embodiment of the decoding apparatus in the present invention

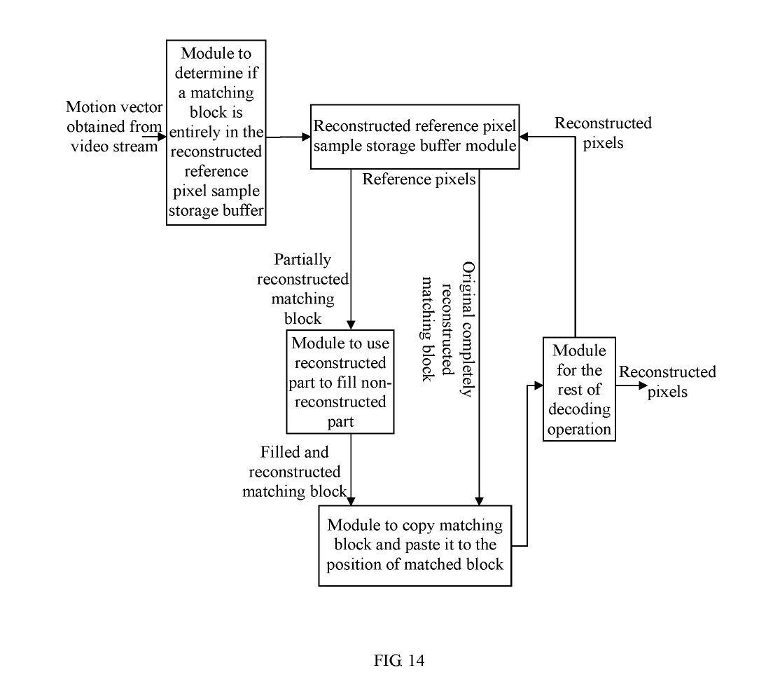

FIG. 15 shows six examples that a portion or entire of a reference pattern provides reference pixels for the rest part of a current pattern in the present invention.

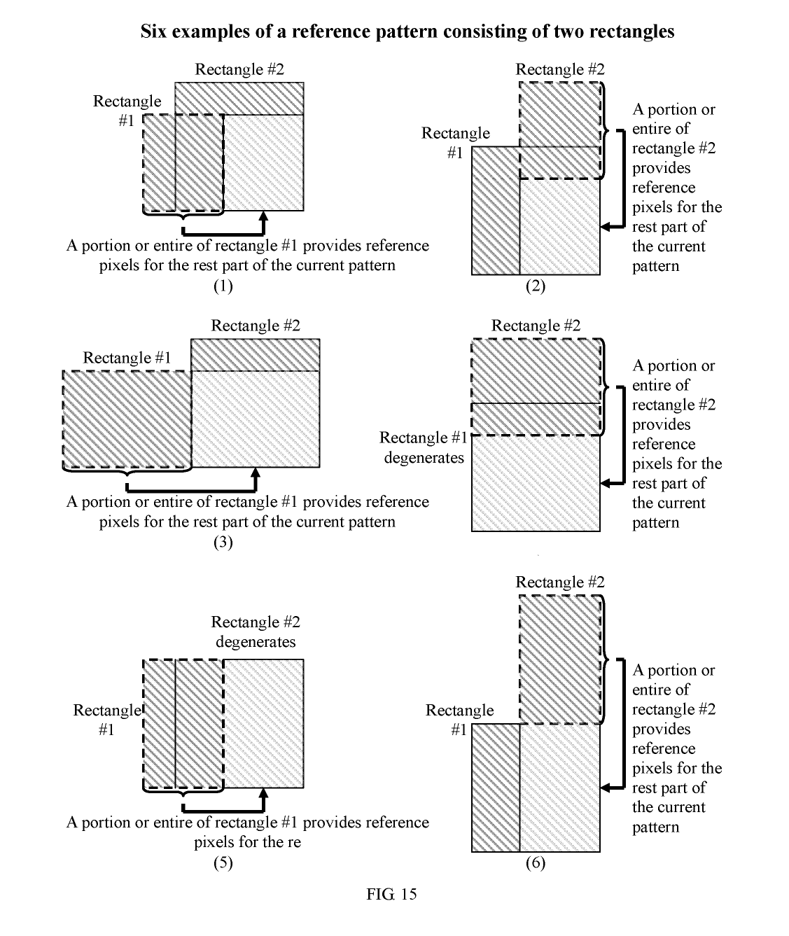

FIG. 16 shows three examples that a reference pattern repeatedly provides reference pixels for the first part and the rest part of a current pattern in the present invention

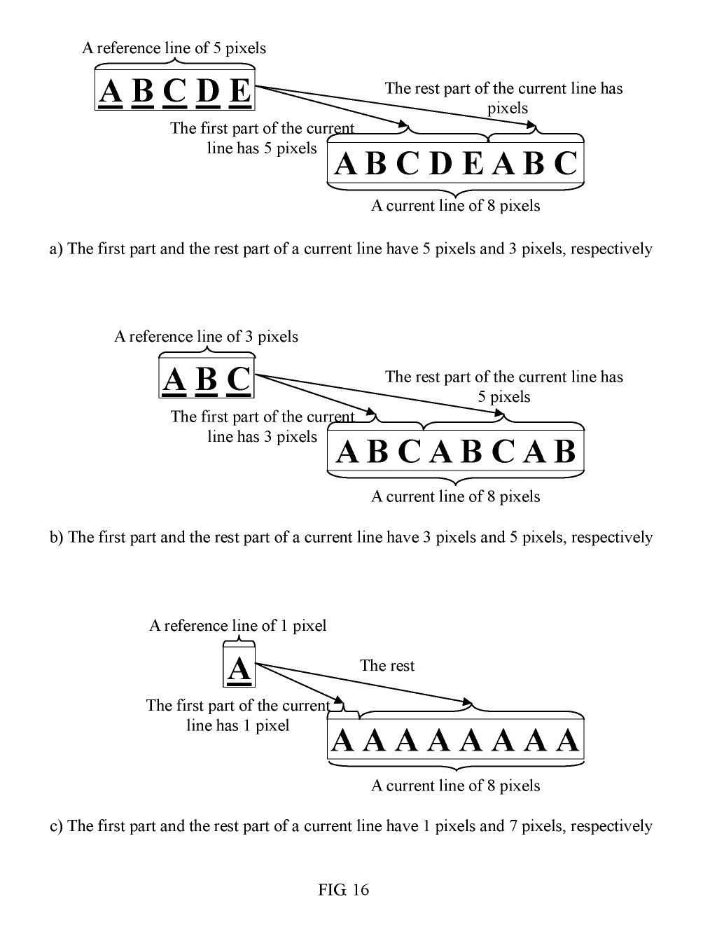

What is claimed is:

1. A method or an apparatus for coding a current pattern using a reference pattern that has different shape and/or size from said current pattern and provides reference pixels for a first part of said current pattern.

2. The method or the apparatus of claim 1 wherein the reference pixels of the rest part of said current pattern are provided by a portion or entire of said first part of said current pattern.

3. The method or the apparatus of claim 1 wherein the reference pixels of the rest part of said current pattern are provided by a portion or entire of said reference pattern.

4. The method or the apparatus of claim 1 wherein said current pattern is a rectangular block and said reference pattern consists of one or multiple rectangular blocks.

5. The method or the apparatus of claim 1 wherein said current pattern is a rectangle and said reference pattern is a Γ-shape pattern.

6. The method or the apparatus of claim 5 wherein a portion or entire of said Γ-shape pattern provides reference pixels for said first part of said current pattern

7. The method or the apparatus of claim 5 wherein a portion or entire of said Γ-shape pattern provides reference pixels for the rest part of said current pattern

8. The method or the apparatus of claim 5 wherein a portion or entire of said Γ-shape pattern repeatedly provides reference pixels for the rest part of said current pattern

9. The method or the apparatus of claim 1 wherein said current pattern is a first rectangle and said reference pattern consists of a second rectangle and a third rectangle.

10. The method or the apparatus of claim 9 wherein a portion or entire of said second rectangle provides reference pixels for said first part of said current pattern.

11. The method or the apparatus of claim 9 wherein a portion or entire of said second rectangle repeatedly provides reference pixels for said first part of said current pattern.

12. The method or the apparatus of claim 9 wherein a portion or entire of said third rectangle provides reference pixels for the rest part of said current pattern.

13. The method or the apparatus of claim 9 wherein a portion or entire of said third rectangle repeatedly provides reference pixels for the rest part of said current pattern.

14. The method or the apparatus of claim 2 wherein a portion or entire of said first part of said current pattern repeatedly provides reference pixels for said rest part of said current pattern.

15. The method or the apparatus of any claim of claims 1 to 14 wherein a said current pattern is a macroblock or a block or a miniblock or a strip or a line or a coding unit or a largest coding unit or a smallest coding unit or a prediction unit.

16. The method or the apparatus of claim 1 wherein said current pattern is a first strip or line and said reference pattern is a second strip or line of different size from said first strip or line.
